(19) United States
(12) Patent Application Publication
(10) Pub. No.: US 2016/0142472 A1
(43) Pub. Date: May 19, 2016

(54) SYSTEM, METHOD, AND MEDIUM

(71) Applicant: FUJITSU LIMITED, Kawasaki-shi (JP)

(72) Inventor: Nobutaka IMAMURA, Yokohama (JP)

(73) Assignee: FUJITSU LIMITED, Kawasaki-shi (JP)

(21) Appl. No.: 14/938,586

(22) Filed: Nov. 11, 2015

(30) Foreign Application Priority Data
Nov. 14, 2014 (JP) 2014-231162

(51) Int. Cl. H04L 29/08; H04L 12/743

(52) U.S. Cl. CPC H04L 67/10; H04L 45/7453

(57) ABSTRACT

A system that includes circuitry configured to receive a plurality of pieces of data; store, for each of the plurality of pieces of data in a first memory area, a first identifier and associated node information identifying a node that processes associated piece of data; delete one of the first identifiers from the first memory area in a case that a number of first identifiers stored in the first memory area reaches a threshold; generate a second identifier based on deleted first identifier by applying a predetermined calculation on the deleted first identifier, the second identifier being shorter than the first identifier; store, in a second memory area, the second identifier and the associated node information; cause a node, associated with one of the first identifier and the second identifier stored in one of the first and second memory area, to process one of the plurality of pieces of data.

### CROSS-REFERENCE TO RELATED APPLICATION

This application is based upon and claims the benefit of priority of the prior Japanese Patent Application No. 2014-231162, filed on Nov. 14, 2014, the entire contents of which are incorporated herein by reference.

### FIELD

The present embodiments relate to a system, a method and a medium.

### BACKGROUND

As a computer system, there is a scalable system operating on a cluster or a cloud. The scalable system is, for example, a distributed key-value store (INS) system, a parallel complex event processing (CEP) system, or the like.

A scalable system performs parallel processing by nodes (computers such as servers) of a number corresponding to the load. The parallel processing includes data parallel processing in which data to be processed is distributed. In a system performing data parallel processing, nodes to process inputted data are managed, for example, in a location management table. In the location management table, a node name of a node to process data is registered in association with the key of the data. Each node identifies a node to process inputted data with reference to the location management table. For example, each node processes inputted data if the node to process the data is the node itself. Also, each node transmits inputted data to another node if the node to process the data is a node other than the node itself.

In the data parallel processing system, the size of the location management table increases as the amount of data to be processed increases. The location management table increased in size occupies the memory capacity of each node. Thus, a hash function is used to reduce the size of the location management table. In this case, the node name is registered in the location management table in association with a hash value. Then, data pieces whose calculation results (hash values) of hash functions for keys are the same are processed by the same node. By using the hash functions, the location management table has only to register a number of entries corresponding to the number of values obtained as calculation results of hash functions, and thereby size enlargement of the location management table may be suppressed.

As a method of managing a large amount of data, there is, for example, a distributed data management method capable of balancing the load among nodes so as to avoid concentration of the load to a specific node when a large number of requests to a specific key occur in a burst. Also, there is a distributed processing control method capable of selecting a distributed processing device identification method suitable for each of multiple use cases which are different in frequency such as an event data occurrence frequency and an event condition update frequency. Further, there is also considered a data relocation apparatus capable of reducing the calculation time for determination processing of a data relocation place.

As examples of prior arts, there are known Japanese Laid-open Patent Publication No. 2008-5449, Japanese Laid-open Patent Publication No. 2013-101446, and Japanese Laid-open Patent Publication No. 2013-117763.

### SUMMARY

According to an aspect of the invention there is discloses a system that includes circuitry configured to receive a plurality of pieces of data; store, for each of the plurality of pieces of data in a first memory area, a first identifier and associated node information identifying a node that processes associated piece of data; delete one of the first identifiers from the first memory area in a case that a number of first identifiers stored in the first memory area reaches a threshold; generate a second identifier based on deleted first identifier by applying a predetermined calculation on the deleted first identifier, the second identifier being shorter than the first identifier; store, in a second memory area, the second identifier and the associated node information; cause a node, associated with one of the first identifier and the second identifier stored in one of the first and second memory area, to process one of the plurality of pieces of data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a function configuration example of a processing apparatus according to a first embodiment;

FIG. 2 illustrates an example of a complex event processing;

FIG. 3 illustrates an example of a data parallel processing;

FIG. 4 illustrates a configuration example of a complex event processing system according to a second embodiment;

FIG. 5 illustrates a hardware configuration example of a computer used in the embodiment;

FIG. 6 is a block diagram illustrating an example of a function of each of nodes;

FIG. 7 illustrates an example of communications among elements within a node;

FIG. 8 is a block diagram illustrating an example of a function of an event transfer unit;

FIG. 9 is a block diagram illustrating an example of a function of a location management part;

FIG. 10 illustrates an example of a VNode map table;

FIG. 11 illustrates an example of an individual key map table;

FIG. 12 is a flowchart illustrating an example of a procedure for an initial storage location setup processing;

FIG. 13 is a flowchart illustrating an example of a procedure for an event reception processing;

FIG. 14 is a flowchart illustrating an example of a procedure for an event transmission processing;

FIG. 15 is a flowchart illustrating an example of a procedure for a location read processing;

FIG. 16 is a flowchart illustrating an example of a procedure for a state information migration processing;

FIG. 17 is a flowchart illustrating an example of a procedure for a location change processing;

FIG. 18 is a flowchart illustrating an example of a procedure for a location write processing;

FIG. 19 is a flowchart illustrating a procedure for a load information record processing relating to a load of the own node;

FIG. 20 is a flowchart illustrating an example of a procedure for a load information record processing relating to a load of the other node;

FIG. 21 is a flowchart illustrating an example of a procedure for an individually managed key replacement processing;

FIG. 22 is a flowchart illustrating an example of a procedure for a replacement target determination processing;

FIG. 23 is a flowchart illustrating an example of a procedure for a replacement processing;

FIG. 24 illustrates a state prior to a replacement; and

FIG. 25 illustrates a state after a replacement.

### DESCRIPTION OF EMBODIMENTS

For example, a data parallel processing system as in a conventional technique is capable of suppressing the size of the location management table by using the hash functions. However, depending on the key distribution, hash values of keys for a large number of inputted data may become uneven, and thereby the load may be uneven among nodes forming the system.

According to one aspect, it is an object of the embodiments to enable suppression of the load difference among nodes.

Hereinafter, the embodiments are described with reference to the accompanying drawings. Each embodiment may be implemented in combination with multiple embodiments within a consistent scope.

### First Embodiment

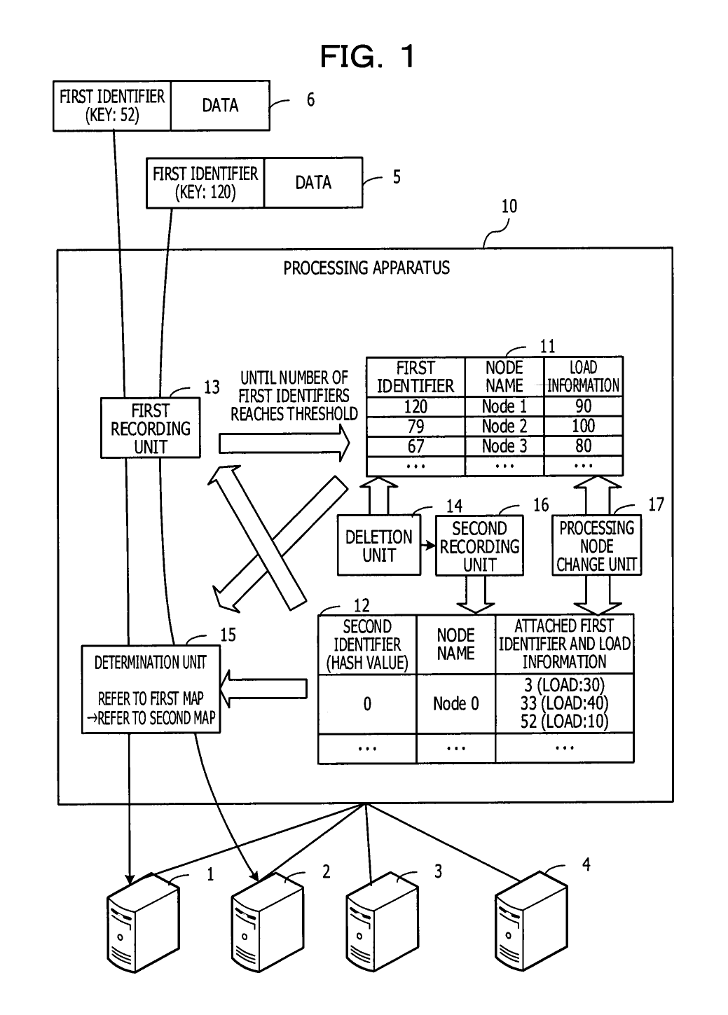

FIG. 1 illustrates a function configuration example of a processing apparatus according to a first embodiment. A processing apparatus 10 according to the first embodiment manages nodes to execute processing of data 5 and 6 which are to be processed in parallel by nodes 1 to 4. A first identifier is assigned to each of data 5 and 6. The first identifier is also referred to, for example, as a key.

The processing apparatus 10 determines a node to process data, based on a first identifier assigned to the data. To determine the node, the processing apparatus 10 includes a first map 11, a second map 12, a first recording unit 13, a deletion unit 14, a determination unit 15, a second recording unit 16, and a processing node change unit 17.

The first map 11 is a storage area of management information for managing the node to process data in units of first identifiers of the data. The first map 11 stores a first identifier assigned to received data, a node to process the data assigned with the first identifier, and load information relating to the processing of the data assigned with the first identifier, in association with one another.

The second map 12 is a storage area of management information for managing a node to process data in units of second identifiers (for example, a hash value) calculated by a predetermined way of calculation using the first identifier assigned to the data. The second map 12 stores a second identifier and a node to process data assigned with a first identifier which becomes the second identifier as a result of the predetermined way of calculation, in association with each other. The second map 12 also stores a first identifier which has become a second identifier by calculation among first identifiers assigned to received data, and load information relating to processing of the data assigned with the first identifier.

The first recording unit 13 records, in the first map 11, a first identifier assigned to received data, a node to process data assigned with the first identifier, and load information relating to processing of data assigned with the first identifier, in association with one another. Load information is acquired from a node which has processed data, for example, after execution of data processing, and then recorded in the first map 11. A predetermined threshold becomes the upper limit of the number of first identifiers which can be recorded in the first map 11. The first recording unit 13 records first identifiers into the first map 11 until the number of first identifiers recorded in the first map 11 reaches the threshold. After the number of first identifiers recorded in the first map 11 reaches the threshold, the first recording unit 13 records no first identifiers into the first map 11 until a first identifier is deleted from the first map 11.

For example, when the number of first identifiers stored in the first map 11 is less than the threshold, the first recording unit 13 selects a first identifier from first identifiers stored in the second map 12 based on load information. The first recording unit 13 records, in the first map 11, a selected first identifier, a node to process data assigned with the first identifier, and load information relating to a processing of data assigned with the first identifier, in association with one another. For example, the first recording unit 13 selects a predetermined number of first identifiers out of first identifiers stored in the second map 12 in descending order of the load indicated in the load information, and records into the first map 11.

When selecting a first identifier stored in the second map 12, the first recording unit 13 selects a predetermined number of second identifiers, for example, in descending order of the total load indicated in the load information of the associated first identifier from the second map 12. Then, the first recording unit 13 selects a first identifier based on the load information out of first identifiers associated with the selected second identifier.

After the number of first identifiers stored in the first map 11 reaches the threshold, the deletion unit 14 selects a first identifier selected based on the load information stored in the first map 11, and deletes the selected first identifier from the first map 11. For example, the deletion unit 14 selects a predetermined number of first identifiers out of multiple first identifiers stored in the first map 11 in ascending order of the load indicated in the load information, and deletes the selected first identifiers.

In response to receipt of data 5 and 6, the determination unit 15 determines, if a first identifier assigned to each of data 5 and 6 is stored in the first map 11, to cause a node associated with each of the first identifiers in the first map 11 to process corresponding data. Also, when the first identifier is not stored in the first map 11, the determination unit 15 determines to cause a node registered in the second map 12 to process data 5 and 6 in association with a second identifier calculated by a predetermined way of calculation for a first identifier assigned to each of data 5 and 6. Then, the determination unit 15 transmits data 5 and 6 to a node determined to process the data.

The second recording unit 16 records, in the second map 12, a first identifier deleted from the first map 11, and load information relating to a processing of data assigned with the first identifier in association with a second identifier calculated by a predetermined way of calculation for the first identifier.

The processing node change unit 17 changes a node associated with the first identifier in the first map 11, and a node associated with the second identifier in the second map 12 so as to reduce the load difference among multiple nodes. For example, the processing node change unit 17 selects a first identifier or a second identifier associated with a node having a higher load, and changes a node associated with the selected first identifier or second identifier to a node having a smaller load.

When such a processing apparatus 10 receives data 5, for example, the first map 11 is referred to, first of all. In the example of FIG. 1, a first identifier “120” of data 5 is stored in a first map 11, and a node 2 with the node name of “Node 1” is associated with the first identifier. Data 5 is transferred to the node 2, and processed in the node 2. When the processing apparatus 10 receives data 6, the first map 11 is referred to, first of all. In the example of FIG. 1, a first identifier “52” of data 6 is not stored in the first map 11. Then, the second map 12 is referred to. Here, assume that result of a predetermined calculation for the first identifier “52” is “0”. In the example of FIG. 1, a node 1 with the node name of “Node 0” is associated with a second identifier “0” in the second map 12. Then, data 6 is transferred to the node 1, and processed in the node 1.

In this way, the first map 11 and the second map 12 are used in combination in the first embodiment as management information for managing nodes that process each data in parallel. Therefore, when the number of first identifiers of received data is small, a node to process each data is managed for each of keys by using the first map 11. Management of the node for each of keys allows adjustment of data processed by the node in a smaller unit and thereby suppresses the load difference among nodes.

As the number of first identifiers increases, a first identifier which is not managed in the first map 11 is managed in the second map 12. The second identifier in the second map 12 has a data length shorter than the first identifier such as, for example, the hash value. Therefore, even if all second identifiers being potentially generated are recorded in the second map 12, the size of the second map 12 is smaller than when all of first identifiers are managed individually. Thus, enlargement of the data amount of management information can be suppressed.

Since the second identifier has a data length shorter than the first identifier, different first identifiers may become an identical second identifier as a result of a predetermined calculation of the first identifiers. Thus, for example, when deleting a first identifier from the first map 11, a first identifier having a relatively high load is left in the first map 11, and a first identifier having a low load is managed by the second map 12 for each of second identifiers, for example, by deleting a predetermined number of first identifiers in the ascending order of the load. Even when multiple first identifiers are included in one second identifier, and data assigned with those first identifiers is processed by the same node, excessive load to the node can be reduced if a load of each of the first identifiers is low. If excessive load to a specific node can be reduced, the load difference among nodes becomes low.

If there is a room in the first map 11, for example, a predetermined number of first identifiers out of first identifiers recorded in the second map 12 in association with second identifiers are recorded in the first map 11 in the descending order of the load. Thus, even a first identifier being managed for each of second identifiers by the second map 12 can be managed for each of first identifiers by recording in the first map 11, if the load thereof is high. Consequently, excessive load to a node associated with one second identifier to which multiple first identifiers are attached can be reduced even when load for processing the data assigned with the first identifiers is high.

Further, when recording, in the first map 11, a predetermined number of first identifiers out of first identifiers recorded in the second map 12 in the descending order of the load, a predetermined number of second identifiers are selected, for example, in the descending order of the total load indicated in the load information of associated first identifiers. Then, a first identifier to be recorded into the first map 11 is selected based on the load information out of first identifiers associated with a selected second identifier. This facilitates load equalization among nodes.

The first recording unit 13, the deletion unit 14, the determination unit 15, the second recording unit 16, and the processing node change unit 17 can be implemented, for example, by a processor of the processing apparatus 10. The first map 11 and the second map 12 can be implemented, for example, by a memory of the processing apparatus 10.

Although in the example of FIG. 1, the processing apparatus 10 is provided separately from nodes 1 to 4, some or all elements of the processing apparatus 10 may be provided in any one of the nodes or in multiple nodes. Lines for coupling elements shown in FIG. 1 with one another indicate a portion of communication paths, and a communication path other than the illustrated communication paths can be set.

### Second Embodiment

Next, a second embodiment is described. In the second embodiment, distributed processing of a large number of data is performed by a complex event processing (CEP) system. In the complex event processing, a large amount of data called big data may be processed.

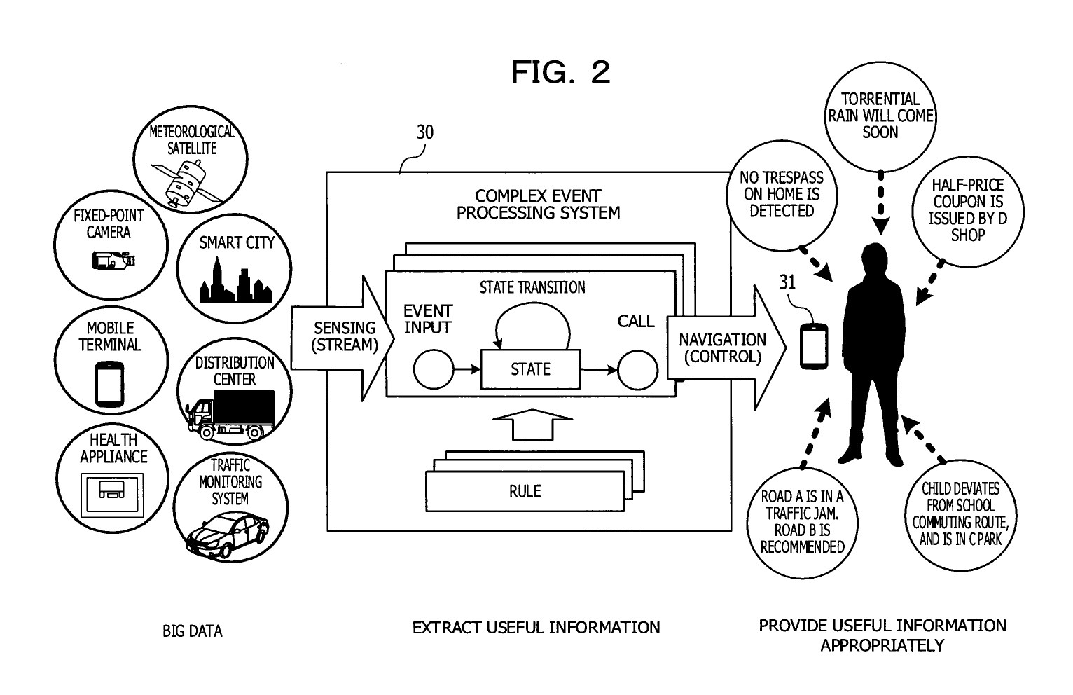

FIG. 2 illustrates an example of the complex event processing. A complex event processing system 30 is a computer system configured to process a large amount of data called big data. For example, the complex event processing system 30 acquires (senses) data from a sensor of various devices. For example, data transmitted from one device is inputted into the complex event processing system 30 as a stream.

Devices having a sensor include devices such as a meteorological satellite, a fixed-point camera, a device incorporated in a smart city, a mobile terminal, a system in a distribution center, a health appliance, and a traffic monitoring system. When the number of sensing targets by a sensor becomes large, data transmitted from each of sensors to the complex event processing system 30 becomes big data.

Upon receiving data, the complex event processing system 30 applies a predetermined rule, and extracts information useful for the user according to the state of the device of the data output source. Then, the complex event processing system 30 navigates the user by controlling, for example, a mobile terminal 31 of the user. Useful information is provided to the user through the navigation.

The complex event processing system 30 performs data parallel processing in order to efficiently process big data.

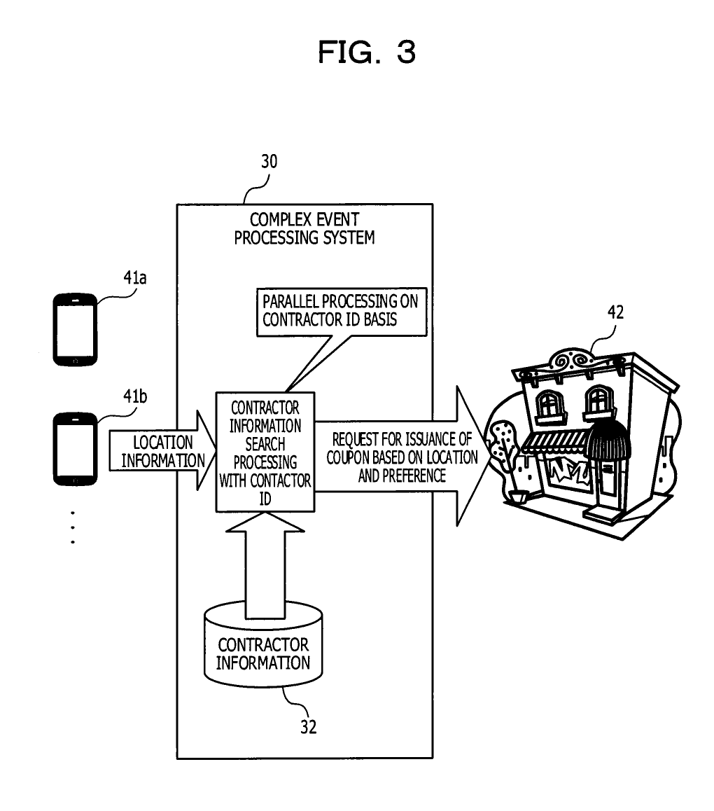

FIG. 3 illustrates an example of the data parallel processing. For example, the complex event processing system 30 maintains contractor information 32 about contractors of services provided by a shop 42. Then, the complex event processing system 30 acquires location information with a contractor ID from management target devices 41a, 41b, . . . of respective contractors. The management target devices 41a, 41b, . . . are, for example, mobile terminals. The complex event processing system 30 processes search of the contractor information 32 for each of contractor IDs in parallel. Then, the complex event processing system 30 transmits a request for issuance of a coupon appropriate for a contractor based on, for example, the location and the preference of the contractor to a server in the shop 42. Then, the server in the shop 42 transmits a coupon appropriate for each of contractors to the management target devices 41a, 41b, . . . owned by contractors.

In the complex event processing system 30, such parallel processing is performed according to various input data. Therefore, when the amount of input data becomes large, data is processed by multiple nodes for efficient processing.

The complex event processing system 30 according to the second embodiment causes any one of multiple nodes to process data input from the management target devices 41a, 41b, . . . as an event based on a key of the event. As a key of the event, for example, an ID of each of the management target devices 41a, 41b, . . . may be used. By allocating an event with an ID of the management target devices 41a, 41b, . . . as a key, data outputted by a management target device may be processed by one node.

Multiple events having an identical key are processed by a node that stores state information for the key. For example, when the key is an ID of the vehicle, state information for the key is information indicating the state of the vehicle (such as whether locked from the outside, whether unlocked properly, and so on). When a sensor of the vehicle detects engine starting operation and transmits data indicating the operation to the complex event processing system 30, event processing is performed according to the data, and if the vehicle is locked from the outside, for example, an alarm is issued to a security center. On the other hand, if the vehicle is unlocked properly, start of the vehicle's operation is recorded by event processing according to the data. Thus, results of event processing differ according to the content of state information for the key. Therefore, multiple events having an identical key are transferred to a server storing the state information of the key. When changing a server which processes an event having the key, the state information is transmitted to a change destination server.

Here, if determination of the executing node is managed by the location management table for all keys, the location management table becomes large as the amount of inputted data increases. For a key of 32-bit unsigned integer type, for example, the maximum number of entries in the location management table is 4 billion. As a result, the memory capacity of each node is pressed. Furthermore, as the number of entries in the location management table increases, the update frequency of the location management table increases, and thereby the processing load of nodes increases.

To reduce enlargement of the location management table, the hash function may be used. When using the hash function, a correspondence relationship between a hash value and a node to process an event having a key which serves as the hash value as a result of the calculation with the hash function is registered in the location management table. By using the hash function, the number of entries registered in the location management table may be suppressed. When a node to process an event is managed with the hash function, a hash value acquired with the hash function may be uneven, and thereby the load may become uneven among nodes.

In the second embodiment, allocation of the event to the node for each of keys, and allocation of the event to the node with the hash function are used in combination to reduce enlargement of the location management table and unevenness of the load among nodes. Hereinafter, a set of keys from which the same hash value is obtained is referred to as a VNode.

By handling the state for each of keys in a batch with the hash function, data parallelism can be drawn out. In the second embodiment, since allocation of the event to the node for each of keys is used in combination, just VNodes enough to draw out data parallelism may be provided, and no further subdivision is desired. For example, data parallelism for about 10 times the number of used nodes is enough. That is, to use 1,000 units of the node, only 10,000 pieces of the VNode may have to be prepared to secure 10,000 parallelisms.

Requirements for management of the correspondence relationship between the key and the node are as follows:

A first requirement is that to obtain high speed performance, the VNode can be identified with a key for each event transfer. In this case, a destination node can be preferably reached by one-time transfer of the event.

A second requirement is that the memory capacity used to maintain the VNode map table is sufficiently small. For example, the number of entries in the VNode map table is preferably suppressed up to about 10,000. Although the load amount for each key is managed in the second embodiment, the correspondence relationship between the VNode and the load amount of each key included in the VNode is preferably managed by any tool other than the map in order to suppress the used memory capacity.

A third requirement is that the load difference between a node for executing an event having a key included in the VNode and a node for executing an event having each of keys managed on a key basis is small. By keeping the load difference small, for example, occurrence of a VNode having a prominently high load may be reduced. A VNode having a prominently high load causes an excessive load to a node to process an event of the VNode, and thereby reduces load equalization among nodes. If occurrence of a VNode having a prominently high load can be suppressed, load equalization among nodes may be facilitated.

Also, the number of attached keys may be equalized as much as possible among multiple VNodes. If no significant difference among loads for each of keys is known, equalization of the load among nodes may be expected by equalizing the number of keys included in the VNode. In particular, when the number of keys included in each VNode is likely to be uneven, equalizing the number of attached keys as much as possible effectively acts for equalization of the load among nodes. The situation where the number of keys included in each VNode is likely to be uneven is, for example, when keys are sparse. The sparse keys indicate that, for example, when keys are expressed with multiple numerals, only discontinuous numerals are used as keys. When the license plate number of the vehicle passing through an interchange of a highway is used as a key, keys become sparse.

A fourth requirement is that when the number of keys is small, the key may be used instead of the VNode. If the number of keys is small, load equalization may be facilitated better by managing an appropriate allocation destination node for each key without using the hash function. Even when the key may be used instead of the VNode, it is preferable that when the number of keys increases, some keys are migrated for management with the VNode, and when the number of keys decreases, a key being managed with the VNode is migrated for management for each of keys. Even when the key management method is migrated between a key basis and a VNode basis to each other, migration may be preferably performed with a small processing load. Also, the difference between the number of processings per unit time for events for keys included in the VNode, and the number of processings per unit time for an event for a key for which the allocation destination node is managed on the key basis is preferably small.

A fifth requirement is that even keys included in an identical VNode can be executed concurrently.

To satisfy the above requirements, the complex event processing system 30 according to the second embodiment manages the correspondence relationship between the key and the node as follows: •Correspondence with the node is maintained with the key in a map for the key. •Correspondence with the node is also maintained in a map for the VNode. •An upper limit is provided in each of both maps, and when the map for the key is full up to the upper limit thereof, a key is migrated to the management for each of VNodes in the ascending order of the load. •A VNode to which a key is migrated is determined by using the hash method, and so on. •Keys are replaced regularly between the map for the key and the map for the VNode so as to equalize the load of the VNode and a single key. •When transferring an event, a key of the event is checked whether the key is allocated to the node independently. If the key does not exist, the event is transferred to a responsible node of the VNode to check for the existence thereof. When preparing a new key, the key is newly prepared on a responsible node of the VNode, which then selects whether the key is placed in the map independently or into the VNode. To share the map by the entire system, when the key is placed in the map independently, a map change request is sent to a manager that manages the correspondence relationship between the key and the node.

Hereinafter, the complex event processing system 30 using an allocation of the event to the node for each of keys and an allocation of the event to the node with the hash function in combination is described in detail.

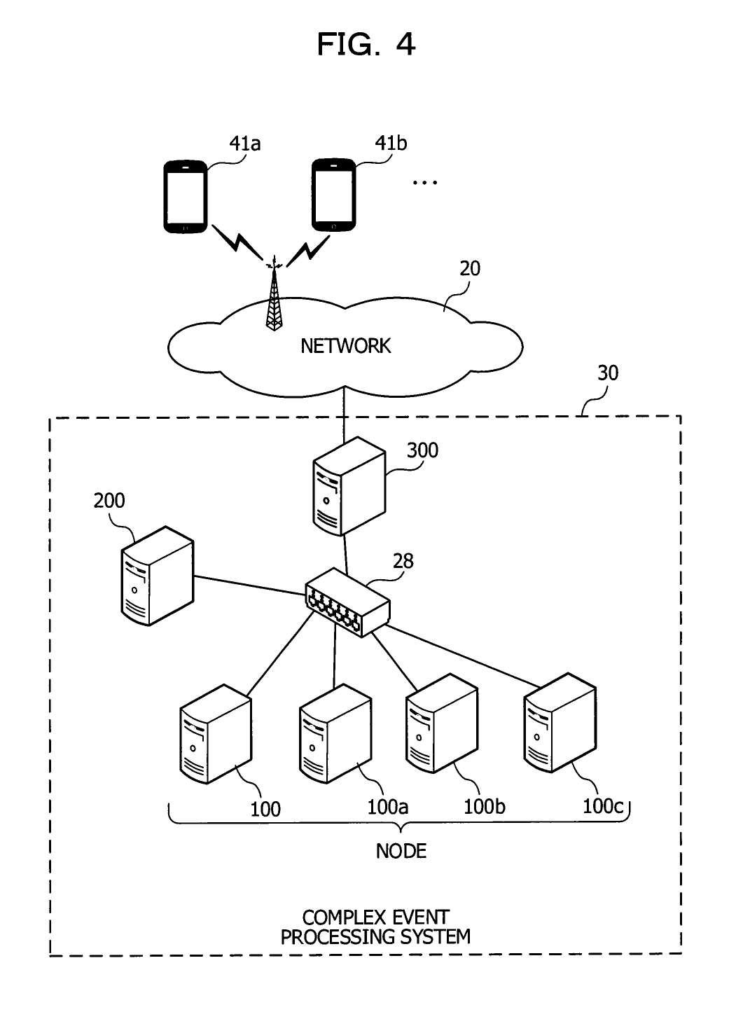

FIG. 4 illustrates a configuration example of the complex event processing system according to the second embodiment. The management target devices 41a, 41b, . . . and a load balancer 300 are coupled with one another via a network 20. The management target devices 41a, 41b, . . . transmit data such as values measured by a sensor to the load balancer 300 via the network 20.

The load balancer 300 is coupled with nodes 100, 100a, 100b, 100c, and a management node 200 via a switch 28. The load balancer 300 allocates data received from the management target devices 41a, 41b, . . . to the nodes 100, 100a, 100b, 100c according to a predetermined algorithm such as the round robin. Each data is transferred to an allocation destination node as an event to be processed.

The nodes 100, 100a, 100b, 100c include location management information for managing the node to process the event. Upon receiving an event, the nodes 100, 100a, 100b, 100c determine with reference to the location management information whether a node to process the data is the own node. A node, which has received an event, executes a processing appropriate for the event if the node to process the event is the own node. Also, a node, which has received an event, transfers the event to a node that executes a processing appropriate for the event if the node to process the event is not the own node.

The management node 200 determines a node to process the event so as to equalize the load, and instructs updating of the location management information of each of the nodes 100, 100a, 100b, 100c. Each of the nodes 100, 100a, 100b, 100c updates the location management information in accordance with the instruction from the management node 200.

The nodes 100, 100a, 100b, 100c manage present state of the management target device at the data transmission source of the event processed by the own node. When causing another node due to updating of the location management information to thereafter process an event which has been processed by the own node, the nodes 100, 100a, 100b, 100c transmit information indicating the state of the management target device at the event transmission source to the node.

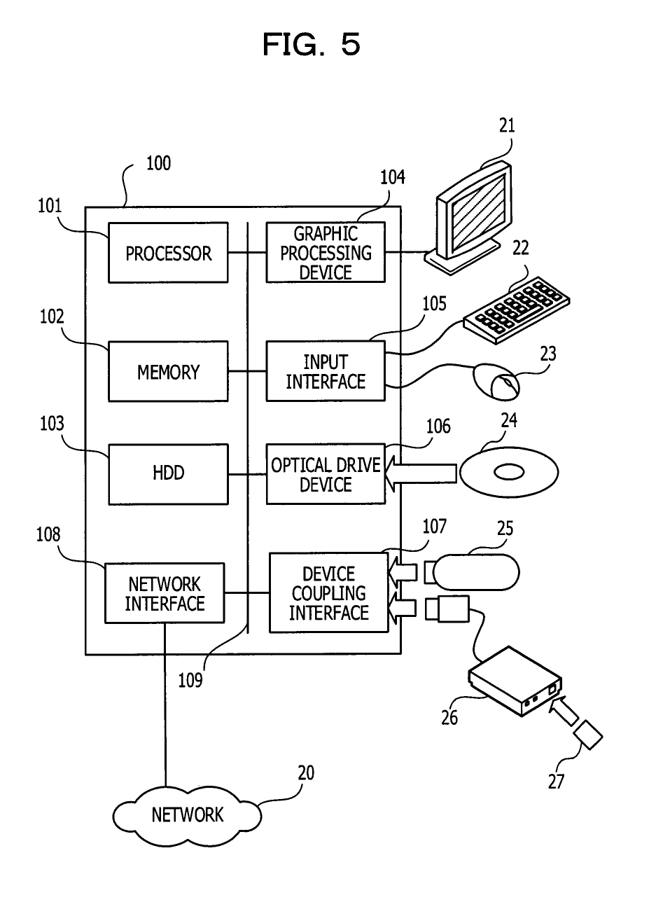

FIG. 5 illustrates a hardware configuration example of a computer used in the embodiment. The node 100 as a whole is controlled by a processor 101. The processor 101 is coupled with a memory 102 and multiple peripheral devices via a bus 109. The processor 101 may be a multiprocessor. The processor 101 is, for example, a central processing unit (CPU), a micro processing unit (MPU), or a digital signal processor (DSP). At least a portion of functions implemented when the processor 101 executes a program may be implemented by an electronic circuit such as an application specific integrated circuit (ASIC) and a programmable logic device (PLD).

The memory 102 is used as a main storage device of the node 100. The memory 102 temporarily stores at least a portion of a program of an operating system (OS) executed by the processor 101 and an application program. Further, the memory 102 stores various data to be used for processing by the processor 101. As the memory 102, a volatile semiconductor storage device such as, for example, a random access memory (RAM) is used.

Peripheral devices coupled to a bus 109 include a hard disk drive (HDD) 103, a graphic processing device 104, an input interface 105, an optical drive device 106, a device coupling interface 107, and a network interface 108.

The HDD 103 magnetically writes and reads data from an incorporated disk. The HDD 103 is used as an auxiliary storage device of the node 100. The HDD 103 stores an OS program, an application program, and various data. The auxiliary storage device may include a nonvolatile semiconductor storage device such as a flash memory.

The graphic processing device 104 is coupled with a monitor 21. The graphic processing device 104 displays an image on a screen of the monitor 21 in accordance with an instruction from the processor 101. The monitor 21 includes a display device and a liquid display device using a cathode ray tube (CRT).

The input interface 105 is coupled with a keyboard 22 and a mouse 23. The input interface 105 transmits signals sent from the keyboard 22 and the mouse 23 to the processor 101. The mouse 23 is an example of the pointing device. Thus, the other pointing device may be used. The other pointing device includes such devices as a touch panel, a tablet, a touch pad, and a truck ball.

The optical drive device 106 reads data recorded in an optical disk 24 by utilizing laser beam, and so on. The optical disk 24 is a portable recording medium in which data is recorded in a manner readable by light reflection. The optical disk 24 includes a digital versatile disc (DVD), a DVD-ram, a compact disc read only memory (CD-ROM), recordable (CD-R)/rewritable (RW), and so on.

The device coupling interface 107 is a communication interface for coupling peripheral devices to the node 100. For example, the device coupling interface 107 may be coupled with a memory device 25 and a memory reader writer 26. The memory device 25 is a recording medium having a function for communicating with the device coupling interface 107. The memory reader writer 26 is a device configured to write data into a memory card 27 or read data from the memory card 27. The memory card 27 is a card type recording medium.

A network interface 108 is coupled to a network 20. The network interface 108 transmits and receives data from other computers or communication devices via the network 20.

With such a hardware configuration, processing functions of the second embodiment may be implemented. The processing apparatus 10 according to the first embodiment may be also implemented by hardware similar with the node 100 illustrated in FIG. 5. The other nodes 100a, 100b, 100c, the management node 200, and the load balancer 300 may be also implemented by hardware similar with the node 100 illustrated in FIG. 5.

The node 100 implements processing functions of the second embodiment by executing, for example, a program recorded in a computer readable recording medium. A program describing the content of a processing to be executed by the node 100 may be recorded in various recording media. For example, a program to be executed by the node 100 may be stored in the HDD 103. The processor 101 implements a program by loading at least a portion of a program in the HDD 103 into the memory 102. A program to be executed by the node 100 may be recorded in a portable recording medium such as the optical disk 24, the memory device 25, and the memory card 27. A program stored in a portable recording medium becomes ready to be executed, for example, after being installed on the HDD 103, for example, by control through the processor 101. Alternatively, the processor 101 may execute the program by directly reading the program from the portable recording medium.

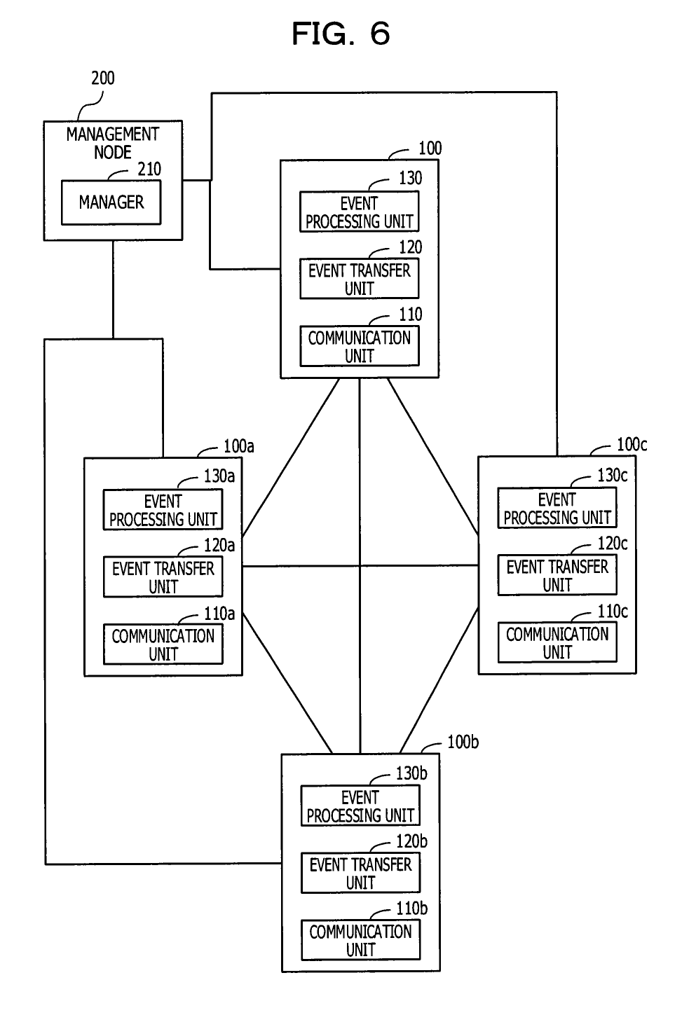

FIG. 6 is a block diagram illustrating an example of functions of each node. The node 100 includes a communication unit 110, an event transfer unit 120, and an event processing unit 130. The communication unit 110 transmits and receives information such as the event to and from other nodes. The event transfer unit 120 transfers an event which has occurred in the event processing unit 130 to the other node, and transfers a received event to the event processing unit 130. The event processing unit 130 processes a received event. Similarly with the node 100, the other nodes 100a, 100b, 100c include communication units 110a, 110b, 110c, event transfer units 120a, 120b, 120c, and event processing units 130a, 130b, 130c in a respectively corresponding manner.

The management node 200 includes a manager 210. The manager 210 manages determination of the node to process the event. For example, the manager 210 changes allocation of the event to the node so as to cause a node having a low load to execute an event being executed by a node having a high load.

Next, the content of communications among elements within the node 100 is described.

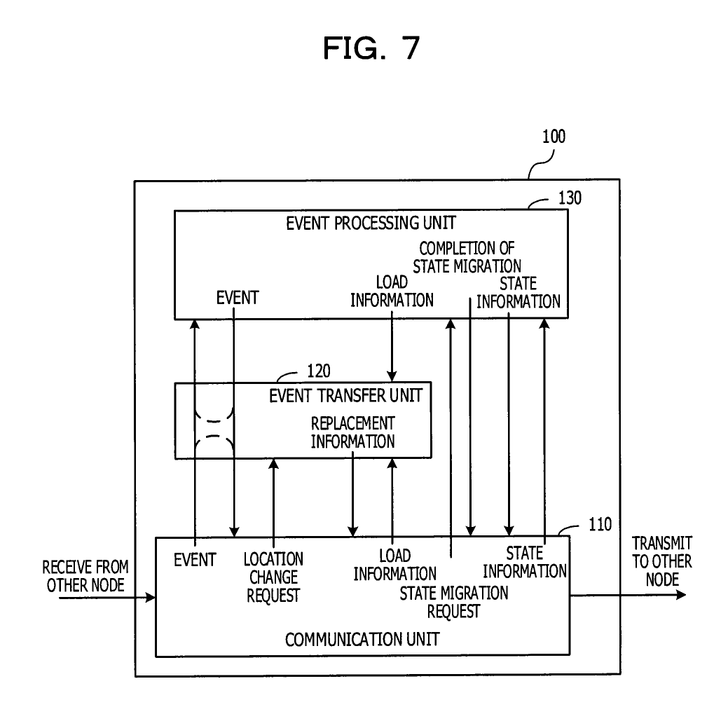

FIG. 7 illustrates an example of communications among elements within the node. Upon receiving an event or load information from the load balancer 300 or the other node, the communication unit 110 transmits the received event or load information to the event transfer unit 120. Upon receiving state information for a key from the other node, the communication unit 110 transmits the state information to the event processing unit 130. Upon receiving a location change request from the management node 200, the communication unit 110 transmits the location change request to the event transfer unit 120. Upon receiving a state migration request from the management node 200, the communication unit 110 transmits the state migration request to the event processing unit 130. Upon receiving an event from the event transfer unit 120, the communication unit 110 transmits the event to a node designated as the address of the event. Upon receiving replacement information from the event transfer unit 120, the communication unit 110 transmits the replacement information to the management node 200. Upon receiving a notification of state migration completion from the event processing unit 130, the communication unit 110 transmits the notification to the management node 200. Upon receiving the state information for a key from the event processing unit 130, the communication unit 110 transmits the state information to a node that thereafter processes an event for the key.

Upon receiving an event from the communication unit 110 or the event processing unit 130, the event transfer unit 120 determines a node to process the event. If the event is an event to be processed by the node 100 itself, the event transfer unit 120 transmits the received event to the event processing unit 130. If the event is an event to be processed by the other node, the event transfer unit 120 designates a node to process the event as the address, and transmits the received event to the communication unit 110. Upon receiving a location change request from the communication unit 110, the event transfer unit 120 updates location management information maintained therein. Upon receiving the load information from the communication unit 110, the event transfer unit 120 updates load information of other nodes maintained therein. Upon replacing an event managed for each of keys and an event managed for each of VNodes with each other, the event transfer unit 120 transmits replacement information indicating the replacement result to the communication unit 110.

Upon receiving an event from the event transfer unit 120, the event processing unit 130 performs a processing of the event. If another event is generated as a result of execution of event processing, the event processing unit 130 transmits the generated event to the event transfer unit 120. The event processing unit 130 transmits load information indicating a load of the node 100 generated by the execution of the event to the event transfer unit 120. Upon receiving a state migration request for a key, the event processing unit 130 transmits the corresponding state information to the communication unit 110.

Next, a function of the event transfer unit 120 is described further in detail.

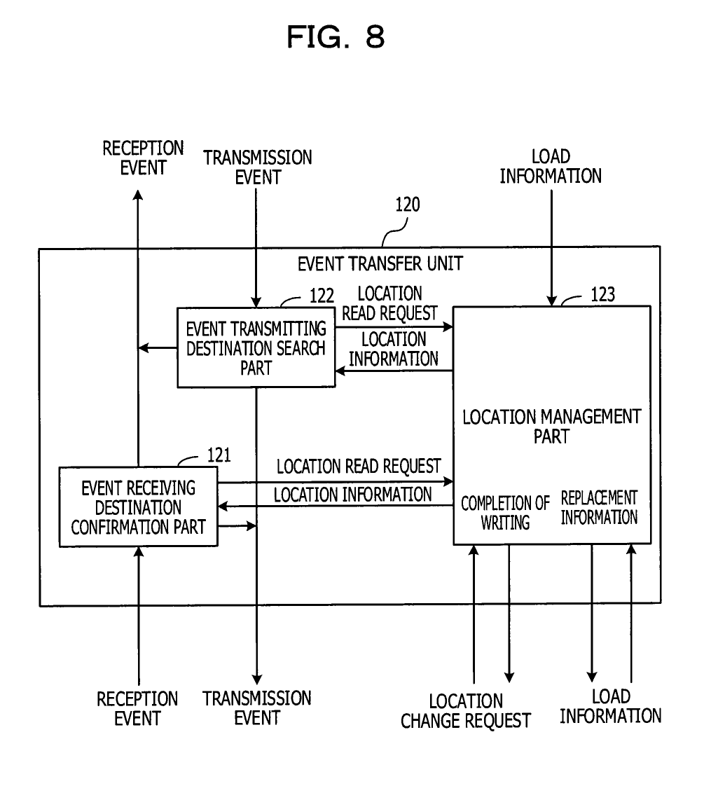

FIG. 8 is a block diagram illustrating an example of the function of the event transfer unit. The event transfer unit 120 includes an event receiving destination confirmation part 121, an event transmitting destination search part 122, and a location management part 123.

Upon acquiring an event (reception event) that the communication unit 110 has received from the other node, and so on, the event receiving destination confirmation part 121 confirms a receiving destination of the received event. For example, the event receiving destination confirmation part 121 transmits a location read request designating a key of the reception event to the location management part 123. The location management part 123 responds by sending, as location information, a location (node name or address) of the node storing state information for the key of the reception event. If the acquired location information is of the node 100 thereof, the event receiving destination confirmation part 121 transmits the reception event to the event processing unit 130. If the acquired location information is of the other node, the event receiving destination confirmation part 121 transmits the reception event to the communication unit 110 as a transmission event addressed to a node indicated in the location information.

Upon acquiring an event (transmission event) issued by the event processing unit 130, the event transmitting destination search part 122 confirms a receiving destination of the transmission event. For example, the event transmitting destination search part 122 transmits a location read request designating a key of the transmission event to the location management part 123. The location management part 123 responds by sending, as location information, a location (node name or address) of the node that stores state information for the key of the transmission event. If the acquired location information is of the node 100 thereof, the event transmitting destination search part 122 transmits the transmission event to the event processing unit 130. If the acquired location information is of the other node, the event transmitting destination search part 122 transmits the transmission event to the communication unit 110 as a transmission event addressed to a node indicated in the location information.

Upon receiving a location read request from the event receiving destination confirmation part 121 or the event transmitting destination search part 122, the location management part 123 refers to a map in which the node to process the event is associated with the key for each of keys or for each of VNodes. Then, the location management part 123 identifies a node associated with the key designated by the location read request based on the referred map. Then, the location management part 123 transmits location information indicating the identified node to the event receiving destination confirmation part 121 or the event transmitting destination search part 122. Upon receiving a location change request from the communication unit 110, the location management part 123 updates a map in which the node to process the event is associated with the key for each of keys or for each of VNodes. Then, after having updated the map, the location management part 123 transmits a write completion response to the communication unit 110. If a key managed for each of keys and a key managed for each of VNodes are replaced with each other, the location management part 123 transmits replacement information indicating the replacement content to the communication unit 110. Further, upon receiving load information of a processing of an event for a key from the communication unit 110 or the event processing unit 130, the location management part 123 stores load information in association with the key.

Next, the function of the location management part 123 is described further in detail.

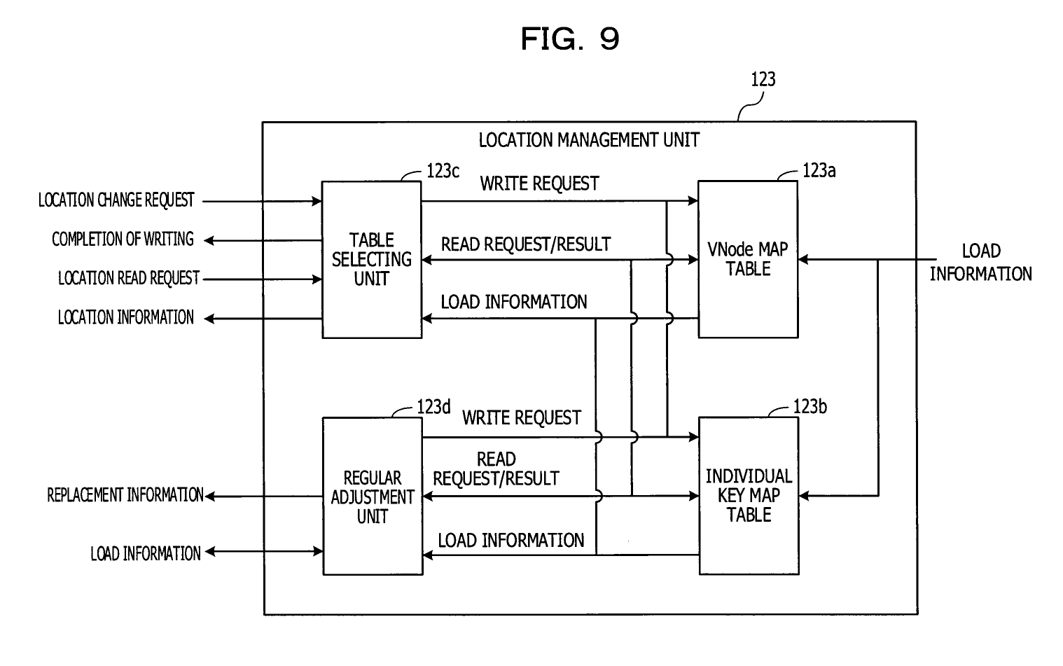

FIG. 9 is a block diagram illustrating an example of the function of the location management part. The location management part 123 includes a VNode map table 123a, an individual key map table 123b, a table selecting part 123c, and a regular adjustment part 123d.

The VNode map table 123a is a data table in which a node to process an event for a key is registered in association with information (for example, a hash value) identifying the key included in the VNode.

The individual key map table 123b is a data table in which a node processing an event is registered in association with a key of the event.

Upon receiving a location change request from the communication unit 110, the table selecting part 123c updates the VNode map table 123a or the individual key map table 123b in accordance with the location change request. For example, assume that change of the node to process an event for a key included in a certain VNode is instructed by the location change request. In this case, the table selecting part 123c outputs a node change write request for an entry for the certain VNode in the VNode map table 123a. Based on the write request, the requested entry in the VNode map table 123a is updated. If change of the node to process an event for a certain key is instructed by the location change request, the table selecting part 123c outputs a node change write request for an entry relating to the certain key in the individual key map table 123b. Based on the write request, the matched entry in the individual key map table 123b is updated. After writing of entry update according to the write request has completed, the table selecting part 123c transmits a write completion response to the communication unit 110.

Upon receiving a location read request from the event receiving destination confirmation part 121 or the event transmitting destination search part 122, the table selecting part 123c outputs a read request from the individual key map table 123b for an entry for a key designated by the location read request. In response to the read request from the individual key map table 123b, the node name of the node associated with the key designated by the read request is outputted as a read result. If the node name is not be detected from the individual key map table 123b, the table selecting part 123c outputs a read request from the VNode map table 123a for an entry for the key designated by the location read request. In response to the read request from the VNode map table 123a, the table selecting part 123c calculates a hash value corresponding to the key with the hash function, and outputs a read request designating the hash value. Then, node name of a VNode corresponding to the designated hash value is outputted from the VNode map table 123a. The table selecting part 123c outputs the node name acquired from the individual key map table 123b or the VNode map table 123a as location information corresponding to the location read request.

The regular adjustment part 123d regularly replaces a key managed for each of keys in the individual key map table 123b and a key managed for each of VNodes in the VNode map table 123a with each other. For example, when replacing keys, the regular adjustment part 123d reads an entry in the individual key map table 123b or the VNode map table 123a, whichever designated by the read request. Also, when replacing keys, the regular adjustment part 123d updates the content of the individual key map table 123b or the VNode map table 123a, designated by the write request to the individual key map table 123b or the VNode map table 123a.

Further, upon receiving load information for each of keys, the regular adjustment part 123d registers the load information in the individual key map table 123b and the VNode map table 123a in association with the key.

Lines for coupling elements in nodes 100, 100a, 100b, 100c illustrated in FIG. 6 to FIG. 9 with one another indicate a portion of communication paths, and a communication path other than the illustrated communication paths can be set. The Function of each of elements illustrated in FIG. 6 to FIG. 9 may be implemented by causing a computer to execute a program module corresponding to each of elements.

Next, the content of each of the map tables is described in detail.

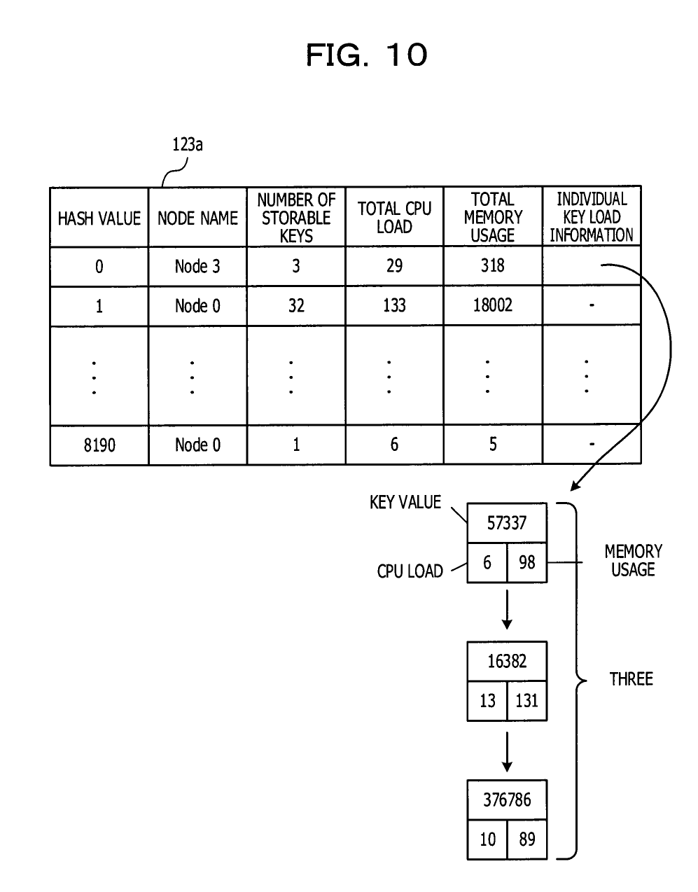

FIG. 10 illustrates an example of the VNode map table. The VNode map table 123a is provided with fields for the hash value, node name, number of storable keys, total CPU load, total memory usage, and individual key load information. The VNode map table 123a contains an entry registered for each of VNodes.

The field of hash value contains a hash value obtained by calculating with the hash function based on a key of an event included in the VNode. As the hash value, for example, the Mersenne number is used. The field of the node name contains the node name of the node that executes the event included in the VNode. The field of the number of storable keys contains the number of keys (storable keys) included in the VNode. The field of the total CPU load contains the load applied to the CPU by executing a processing of the event having a storable key. The CPU load is represented by, for example, the use frequency of CPU. Also, the CPU use rate may be used as the load. The field of the total memory usage contains the total amount of memory used by executing a processing of an event having a storable key.

The field of the individual key load information contains load information (individual key load information) of each of keys included in the VNode for an event executed by the own node. The individual key load information includes, for example, a key value, and a CPU load and a memory usage by executing an event having the key. In the example of FIG. 10, the node name of the node 100 itself is “Node 3”, and the individual key load information is set up only for entries carrying “Node 3” in the field of the node name. For entries for a node other than the node 100, the field of the individual key load information is empty. Size of the VNode map table 123a can be reduced by setting up the individual key load information only for an entry of the VNode relating to an event executed by the own node. Also, the field of the individual key load information contains individual key load information, for example, in a linked list format.

Although the VNode map table 123a is illustrated in a table image in FIG. 10 for easy understanding, it may be of a structure like HashMap.

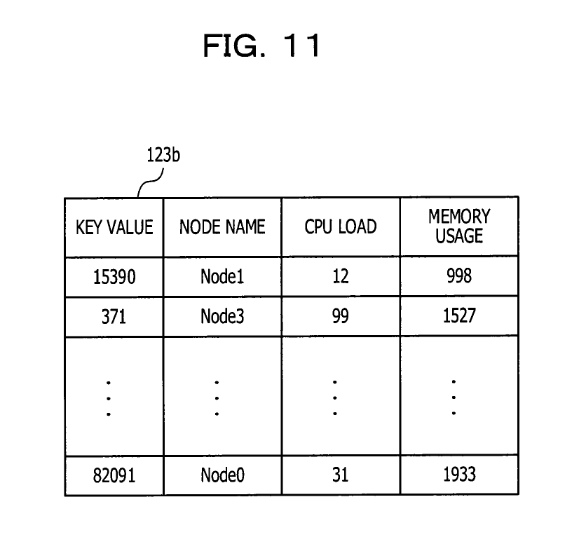

FIG. 11 illustrates an example of the individual key map table. The individual key map table 123b includes fields of the key value, node name, CPU load, and memory usage. The individual key map table 123b contains an entry registered for each of keys managed on a key basis.

The field of the key value contains the value of a key (key value) of a generated event. The field of the node name contains the node name of the node that executes the event having a corresponding key. The field of the CPU load contains the CPU load due to the execution of a processing of an event having a corresponding key. The field of the memory usage contains the memory usage due to the execution of a processing of an event having a corresponding key.

Although the individual key map table 123b is illustrated in a table image in FIG. 11 for easy understanding, it may be of a structure like HashMap.

With a system of such configuration, complex event processing by data parallelism is performed. Nodes processing each data are managed with the VNode map table 123a and the individual key map table 123b. Processes for the management of the node processing each data are described in detail.

Before starting to operate the complex event processing system 30, an initial storage location setup processing for the VNode map table 123a is performed.

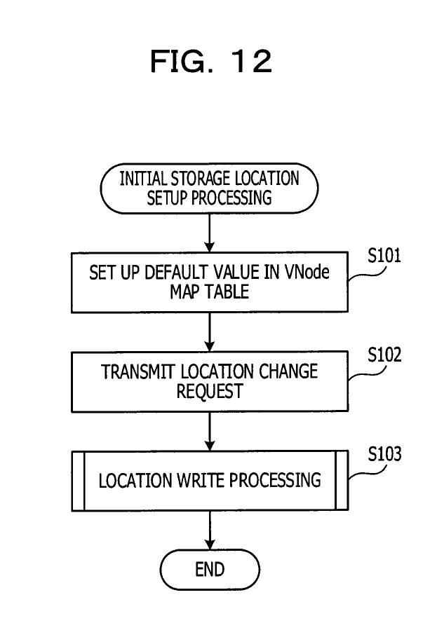

FIG. 12 is a flowchart illustrating an example of a procedure for the initial storage location setup processing.

(Step S101) The location management part 123 of the node 100 sets a default value to the VNode map table 123a. For example, the location management part 123 sets a generable hash value in the field of the hash value in the VNode map table 123a. Also, the location management part 123 sets a default value such as 0 or null in each field other than the field of the hash value in the VNode map table 123a. The similar default value setup processing is performed also for the other nodes 100a, 100b, 100c.

(Step S102) A manager 210 of the management node 200 determines a node to process an event having a key included in a corresponding VNode for each of generable hash values. For example, the manager 210 determines a node to process an event having a key included in the VNode such that the number of VNodes processed by each of the nodes 100, 100a, 100b, 100c is equalized. Then, the manager 210 transmits, to the nodes 100, 100a, 100b, 100c, a location change request indicating a node at the location where an event having a key included in the VNode is executed, for each of VNodes. The location change request includes, for example, a pair of the hash value and the node name of the node executing an event having a key from which the hash value can be obtained. For example, the location change request transmitted to the node 100 is sent from the communication unit 110 to the event transfer unit 120. In the event transfer unit 120, the location management part 123 receives the location change request.

(Step S103) The event transfer unit 120 of the node 100, the event transfer unit 120a of the node 100a, the event transfer unit 120b of the node 100b, and the event transfer unit 120c of the node 100c perform location write processing. By the location write processing, a node name is set in the VNode map table in each of the nodes 100, 100a, 100b, and 100c in association with the hash value of the VNode.

After performing such initial storage location setup processing, operation of the system is started. After the system has been started, data is inputted from management target devices 41a, 41b, . . . , and an event processing the input data is generated. The generated event is transferred to any one of the nodes by the load balancer 300. In a node which has received the event, event reception processing is performed.

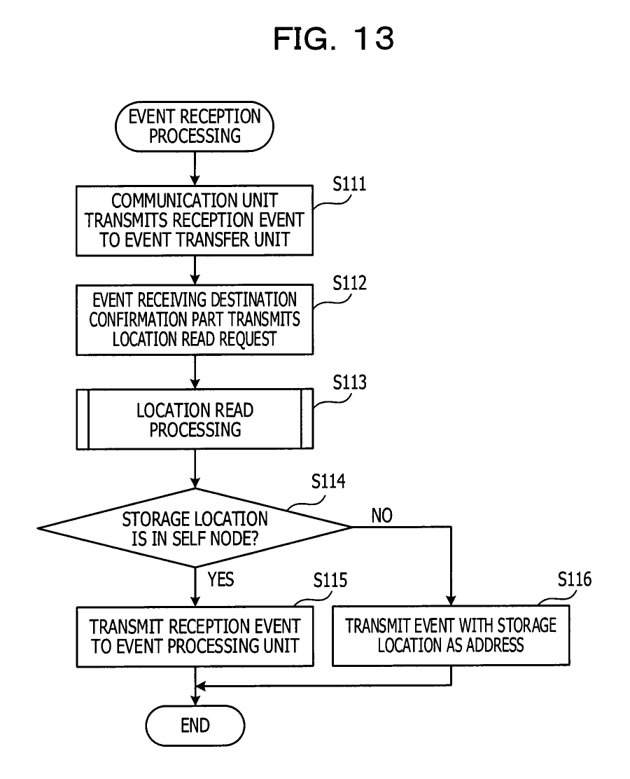

FIG. 13 is a flowchart illustrating an example of a procedure for the event reception processing. Hereinafter, the event reception processing is described on assumption that the node 100 has received an event.

(Step S111) The communication unit 110 transmits the reception event to the event transfer unit 120.

(Step S112) In the event transfer unit 120, the event receiving destination confirmation part 121 designates a key of the reception event, and transmits a location read request to the location management part 123.

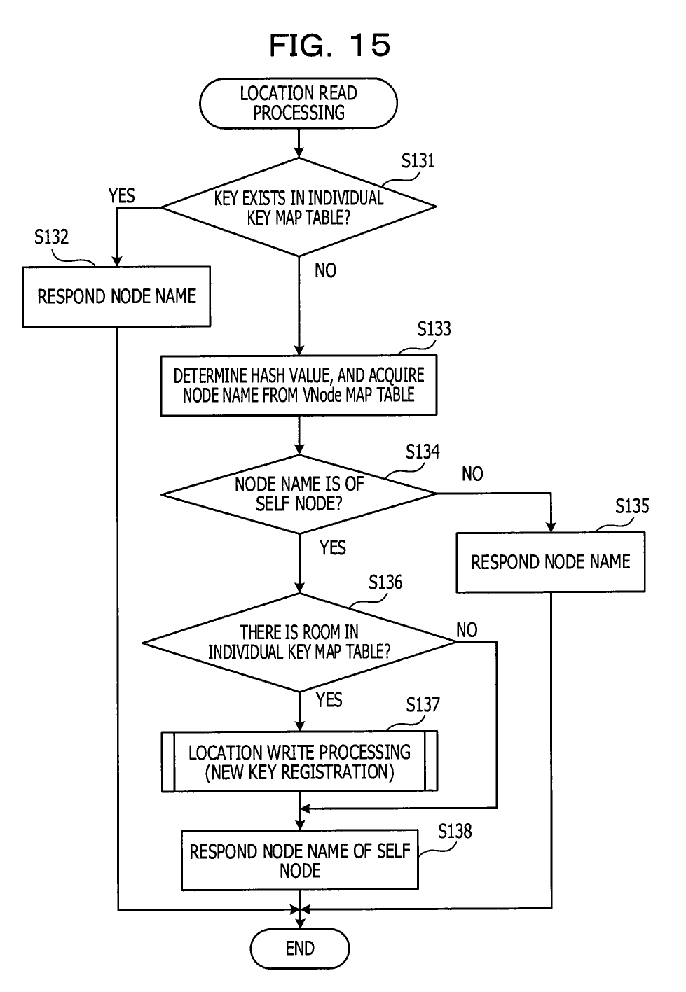

(Step S1.13) The location management part 123 performs location read processing of state information for the designated key. Detail of the processing is described later (see FIG. 15).

(Step S114) The event receiving destination confirmation part 121 receives location information from the location management part 123, and determines whether the node name indicated in the location information is the own node (node 100). If the node name indicated in the location information is the own node, the process proceeds to the step S115. If the node name indicated in the location information is not the own node, the process proceeds to the step S116.

(Step S115) If the node name in the location information is the own node, the event receiving destination confirmation part 121 transmits the reception event to the event processing unit 130, and ends the event reception processing.

(Step S116) If the node name in the location information is not the own node, the event receiving destination confirmation part 121 changes the reception event to a transmission event addressed to the node name of the acquired location information, and requests the communication unit 110 to transmit the transmission event. Then, the communication unit 110 transmits the transmission event to a node designated with the address. Then, the event reception processing ends.

When the event is executed by the event processing unit 130, the other event may be generated. If an event is generated, transmission processing of the event is performed.

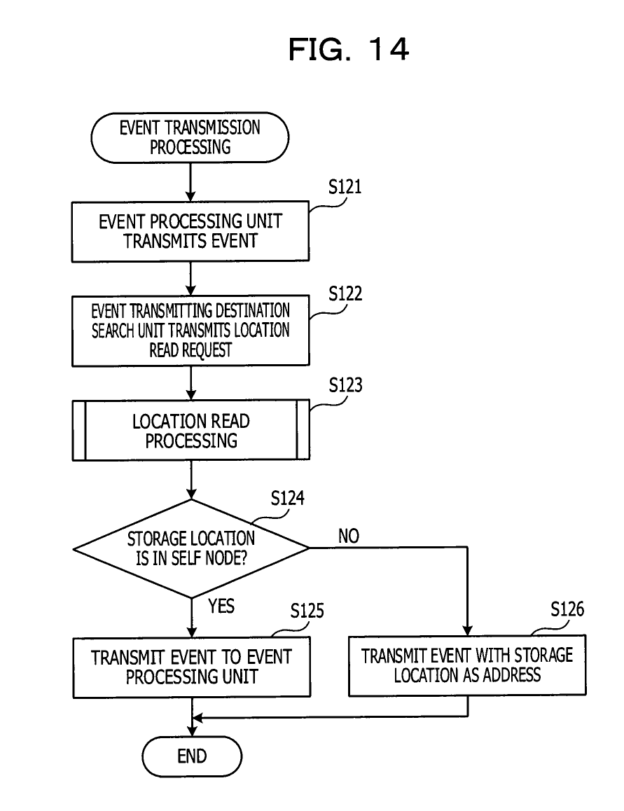

FIG. 14 is a flowchart illustrating an example of a procedure for the event transmission processing.

(Step S121) The event processing unit 130 assigns a key to the generated event, and transmits the event as a transmission event to the event transfer unit 120.

(Step S122) In the event transfer unit 120, the event transmitting destination search part 122 designates a key of the transmission event, and transmits a location read request to the location management part 123.

(Step S123) The location management part 123 performs a location read processing of state information for the designated key. Detail of the processing is described later (see FIG. 15).

(Step S124) The event transmitting destination search part 122 receives location information from the location management part 123, and determines whether the node name indicated in the location information is the own node (node 100). If the node name indicated in the location information is the own node, the process proceeds to the step S125. If the node name indicated in the location information is not the own node, the process proceeds to the step S126.

(Step S125) If the node name in the location information is the own node, the event transmitting destination search part 122 transmits the transmission event to the event processing unit 130, and ends the event reception processing.

(Step S126) If the node name of the location information is not the own node, the event transmitting destination search part 122 requests the communication unit 110 to transmit the transmission event with the node name of the acquired location information as the address of the transmission event. Then, the communication unit 110 transmits the transmission event to the node designated with the address. Then, the event reception processing ends.

Next, a location read processing performed in the step S113 or the step S123 is described in detail.

FIG. 15 is a flowchart illustrating an example of a procedure for the location read processing.

(Step S131) The table selecting part 123c of the location management part 123 determines with reference to the individual key map table 123b whether the key designated by the location read request exists. If the key exists, the process proceeds to the step S132. If the key does not exist, the process proceeds to the step S133.

(Step S132) The table selecting part 123c extracts an entry having a key designated by the location read request from the individual key map table 123b, and acquires a node name within the entry. Then, the table selecting part 123c responds to the transmission source of the location read request by sending the node name as the location information. Then, the location read processing ends.

(Step S133) If the corresponding key does not exist, the table selecting part 123c calculates a hash value of the key. The table selecting part 123c acquires a node name from an entry for the calculated hash value in the VNode map table 123a.

(Step S134) The table selecting part 123c determines whether the acquired node name is the node name of the own node (node 100). If the node name is the node name of the own node, the process proceeds to the step S136. If the node name is not the node name of the own node, the process proceeds to the step S135.

(Step S135) If the node name is not of the own node, the table selecting part 123c responds to the transmission source of the location read request by sending the acquired node name as location information of the address. Then, the location read processing ends.

(Step S136) If the node name is of the own node, the table selecting part 123c determines whether there is a room in the individual key map table 123b. For example, a maximum number of entries in the individual key map table 123b is set up in the location management part 123. It is determined that there is a room in the individual key map table 123b if the present number of entries therein is less than the maximum number of entries. If there is a room, the process proceeds to the step S137. If there is not a room, the process proceeds to the step S138.

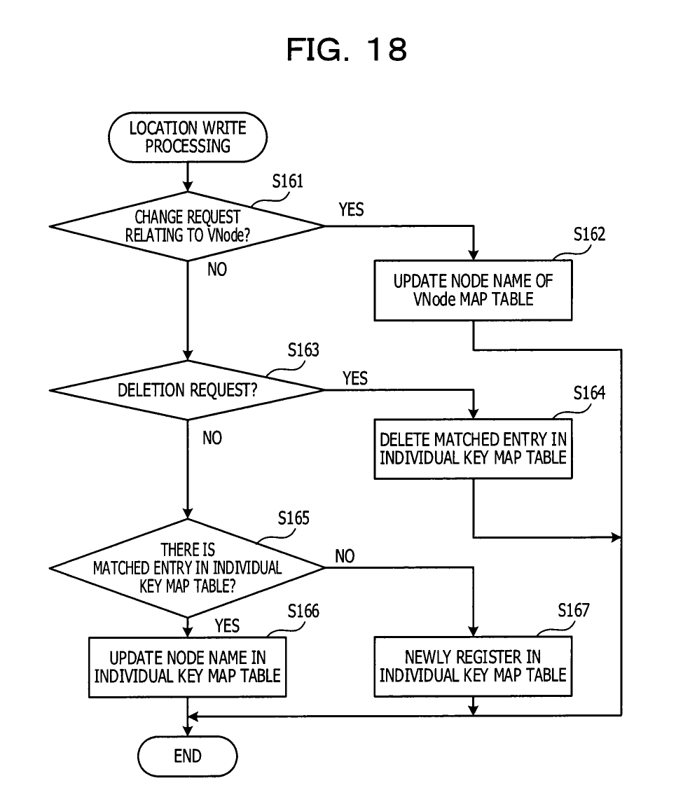

(Step S137) The table selecting part 123c performs a location write processing for new key registration. By performing this processing, a key value and a node name of the own node are recorded into a free entry of the individual key map table 123b. Detail of the location write processing is described later (see FIG. 18).

(Step S138) The table selecting part 123c responds to the transmission source of the location read request by sending the node name of the own node as the location information of the address. Then, the location read processing ends.

In the location read processing, if a location read request for a key managed for each of VNodes is issued, a node to process an event having the key is the own node, and if there is a room in the individual key map table 123b, management of the key is migrated to the key basis. That is, a key value and a node name relating to the key are written into the individual key map table 123b. Thus, keys are migrated from management on a VNode basis to management on the key basis in the order of the used key.

Migration between management on a VNode basis and management on the key basis is also performed by the location change processing according to the location change request from the manager 210. For example, the manager 210 changes the node executing the processing of an event for a key or VNode so as to reduce the load difference among nodes. When changing the node, state information for each of keys is migrated prior to the location change processing.

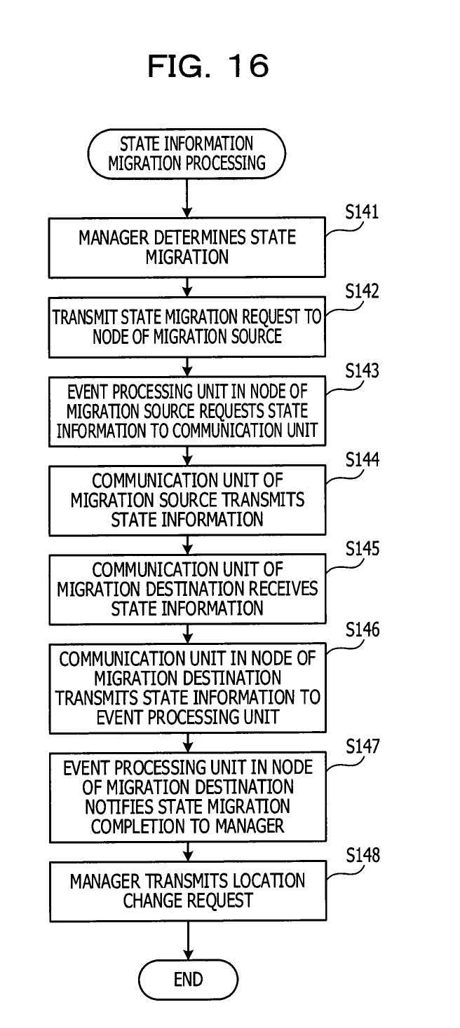

FIG. 16 is a flowchart illustrating an example of a procedure for the state information migration processing.

(Step S141) The manager 210 determines, based on the load information notified by each of the nodes 100, 100a, 100b, and 100c, whether the state information has to be migrated. For example, when the load difference among nodes is larger than a predetermined value, the manager 210 determines to migrate the state information. When migrating the state information, the manager 210 determines to migrate state information for a key or a VNode processed by a node with a high load to a node with a low load.

Hereinafter, processings of steps S142 to S147 are described on assumption that the state information is migrated from the node 100a to the node 100.

(Step S142) The manager 210 transmits a state migration request to the event processing unit 130a of the node 100a having state information to be migrated, by designating state information to be migrated, and the node 100 of the migration destination.

(Step S143) Upon receiving the state migration request, the event processing unit 130a of the node 100a transmits the state information to the communication unit 110a, and requests transmission of the state information to the node 100 of the migration destination.

(Step S144) The communication unit 110a transmits the state information to the node 100.

(Step S145) In the node 100 of the migration destination, the communication unit 110 receives the state information.

(Step S146) The communication unit 110, which has received the state information, transfers the state information to the event processing unit 130.

(Step S147) The event processing unit 130 maintains the received state information, and transmits a notification of state migration completion for the manager 210 to the communication unit 110. The communication unit 110 transmits the notification of state migration completion to the manager 210.

(Step S148) The manager 210 transmits the location change request to all of the nodes 100, 100a, 100b, and 100c such that each of nodes processing an event having each key is changed concurrently with the migration of state information.

The location change request transmitted by the manager 210 is received by the nodes 100, 100a, 100b, and 100c. Then, the location change processing is performed in each of the nodes 100, 100a, 100b, and 100c. Hereafter, a change processing in the node 100 is described in detail.

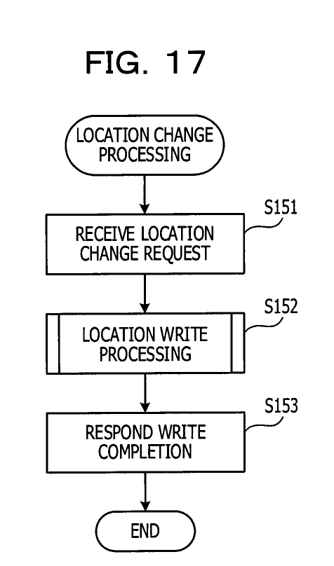

FIG. 17 is a flowchart illustrating an example of a procedure for the location change processing.

(Step S151) The communication unit 110 receives a location change request from the manager 210. The communication unit 110 transmits the received location change request to the event transfer unit 120.

(Step S152) The location management part 123 in the event transfer unit 120 performs a location write processing. Detail of the location write processing is described later (see FIG. 18).

(Step S153) After the location write processing ends, the location management part 123 transmits a write completion response to the communication unit 110. The communication unit 110 transmits the write completion response to the manager 210.

FIG. 18 is a flowchart illustrating an example of a procedure for the location write processing.

(Step S161) The table selecting part 123c of the location management part 123 determines whether the received location change request is a location change request relating to the VNode. The location change request relating to the VNode is a request for changing a node that executes an event having a key included in a specific VNode. The location change request relating to the VNode includes a hash value corresponding to a key included in the VNode, and a node name of a change destination node. If the location change request is a location change request relating to the VNode, the process proceeds to the step S162. If the location change request is not a location change request relating to the VNode, the location change request is determined to be a location change request relating to the key, and the process proceeds to the step S163.

The location change request relating to the key includes a request for deleting an entry of a key from the individual key map table 123b, and a request for registering a node name corresponding to a key. The location change request relating to the key contains the key value of the key. If the location change request relating to the key is a request for registering the node name corresponding to the key, a node name to be registered is contained in the location change request.

(Step S162) If the location change request is a location change request relating to the VNode, the table selecting part 123c searches a record corresponding to a hash value indicated in the location change request from the VNode map table 123a. Then, the table selecting part 123c updates the node name of the corresponding record to the node name indicated in the location change request. Then, the location write processing ends.

(Step S163) If the location change request is a location change request relating to the key, the table selecting part 123c determines whether the location change request is a request for deleting an entry of a key. If the location change request is the deletion request, the process proceeds to the step S164. If the location change request is not the deletion request, the process proceeds to the step S165.

(Step S164) If the location change request is a request for deleting an entry of a key, the table selecting part 123c searches the individual key map table 123b for an entry for the key indicated in the location change request. Then, the table selecting part 123c deletes the searched-out entry. Then, the location write processing ends.

(Step S165) If the location change request is not a request for deleting an entry of a key, the table selecting part 123c determines whether an entry for the key indicated in the location change request exists in the individual key map table 123b. If there is the entry, the process proceeds to the step S166. If there is not the entry, the process proceeds to the step S167.

(Step S166) The table selecting part 123c extracts the entry for the key indicated in the location change request from the individual key map table 123b. Then, the table selecting part 123c changes the node name of the entry to the node name indicated in the location change request. Then, the location write processing ends.

(Step S167) The table selecting part 123c writes a key value and a node name indicated in the location change request into a free entry of the individual key map table 123b. Then, the location write processing ends.

Thus, a node executing an event for a key or a VNode is changed. As a result that the node is changed so as to reduce the load among nodes, the load among nodes in a system is equalized, and thereby operation efficiency of the system is improved.

Load information is recorded in each node as appropriate in order to appropriately determine the load of nodes by the key or the VNode. Each of nodes records load information of the own node, and load information of other nodes all together. Load information of the own node includes a load for each of keys, and a load for each of VNodes. Recorded load information of other nodes includes a load for each of VNodes. Hereinafter, a load information record processing is described in detail.

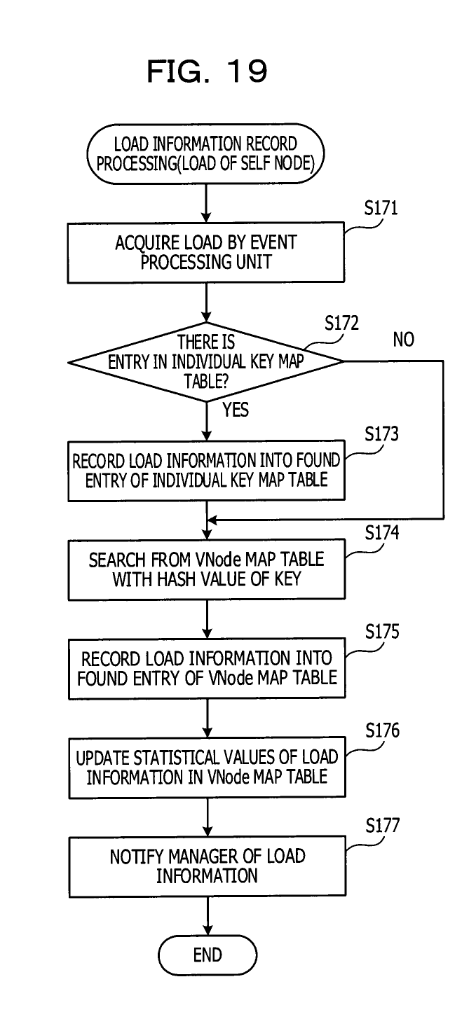

FIG. 19 is a flowchart illustrating a procedure for the load information record processing relating to the load of the own node.

(Step S171) The event processing unit 130 of the node 100 acquires a load for each of keys of an event regularly processed by the own node. For example, the event processing unit 130 acquires a CPU load of a process for processing an event, and a memory usage for the process from OS. The event processing unit 130 transmits the acquired load information to the location management part 123 in association with a key of the corresponding event.

(Step S172) The location management part 123 determines whether there is an entry in the individual key map table 123b corresponding to a key associated with the load information. If there is the entry, the process proceeds to the step S173. If there is not the entry, the process proceeds to the step S174.

(Step S173) The location management part 123 records received load information (CPU load and memory usage) into an entry in the individual key map table 123b corresponding to a key associated with the load information.

(Step S174) The location management part 123 calculates the hash value of a key associated with the received load information, and searches an entry associated with the hash value from the VNode map table 123a.

(Step S175) The location management part 123 records the received load information into the individual key load information of the entry in the VNode map table 123a.

(Step S176) The location management part 123 updates statistical values (total CPU load and total memory usage) of the entry in the VNode map table 123a.

(Step S177) The location management part 123 notifies load information for each of keys to the manager 210.

Thus, load information relating to the load of the own node is recorded.

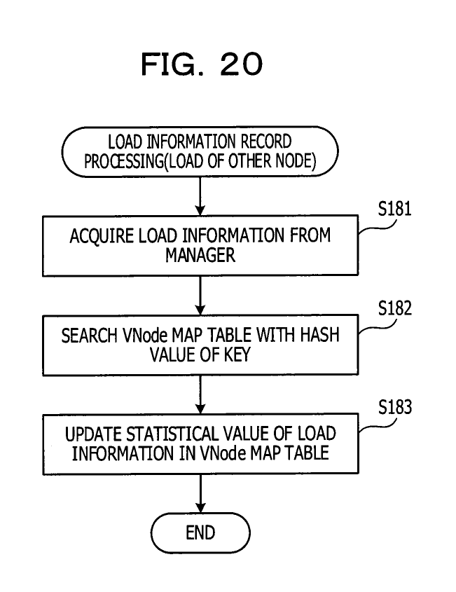

FIG. 20 is a flowchart illustrating an example of a procedure for a load information record processing relating to the load of other node.

(Step S181) The location management part 123 regularly acquires load information for each of keys of other nodes from the manager 210.

(Step S182) The location management part 123 calculates the hash value of a key corresponding to the load information, and searches an entry for the hash value from the VNode map table 123a.

(Step S183) The location management part 123 updates statistical values (total CPU load and total memory usage) of the entry in the VNode map table 123a.

Thus, the location management part 123 may update the load information. Then, the regular adjustment part 123d of the location management part 123 regularly performs a processing of replacing a key managed on a key basis (individually managed key).

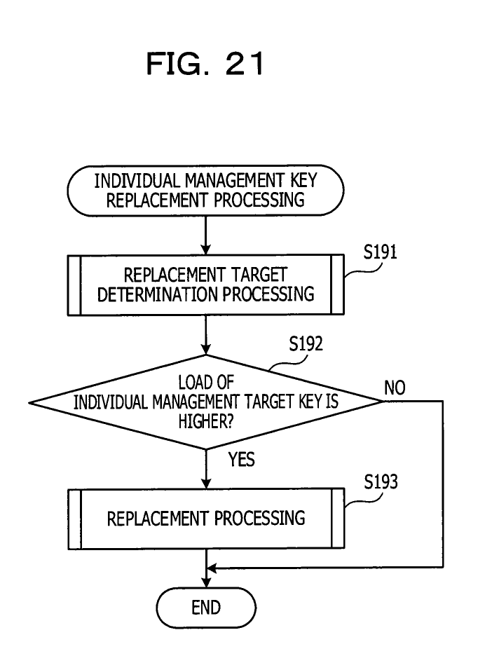

FIG. 21 is a flowchart illustrating an example of a procedure for the individually managed key replacement processing.

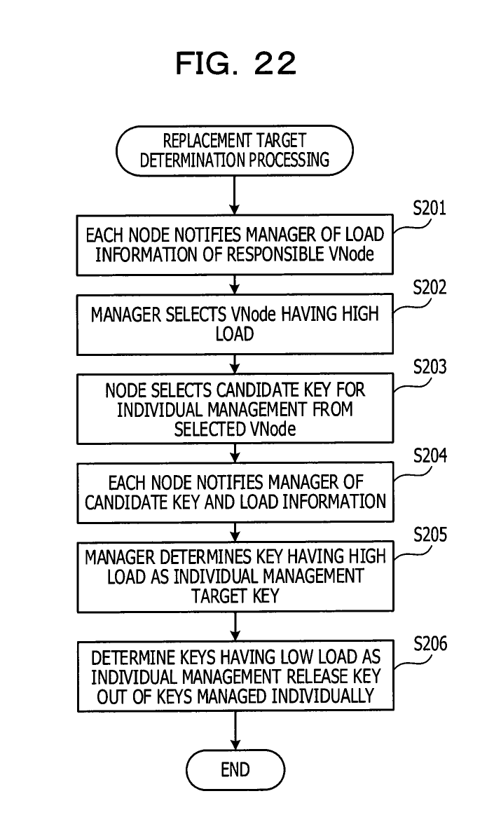

(Step S191) The manager 210 and each of nodes perform a replacement target key determination processing in coordination with one another. Detail of the replacement target determination processing is described later (see FIG. 22).

Hereinafter, change of management of the key from the VNode basis to the key basis is referred to as individual management. Reversely, change of management of the key from the key basis to the VNode basis is referred to as individual management release.

(Step S192) The manager 210 compares a load of an individual management release target key and a load of an individual management target key with each other. Then, the manager 210 authorizes replacement only when the load of the individual management target key is higher than the load of the individual management release target key. Once the manager 210 has authorized the replacement, the regular adjustment part 123d is notified thereof. If the replacement is authorized, the process proceeds to the step S193. If replacement of all keys is not authorized, the replacement processing ends.

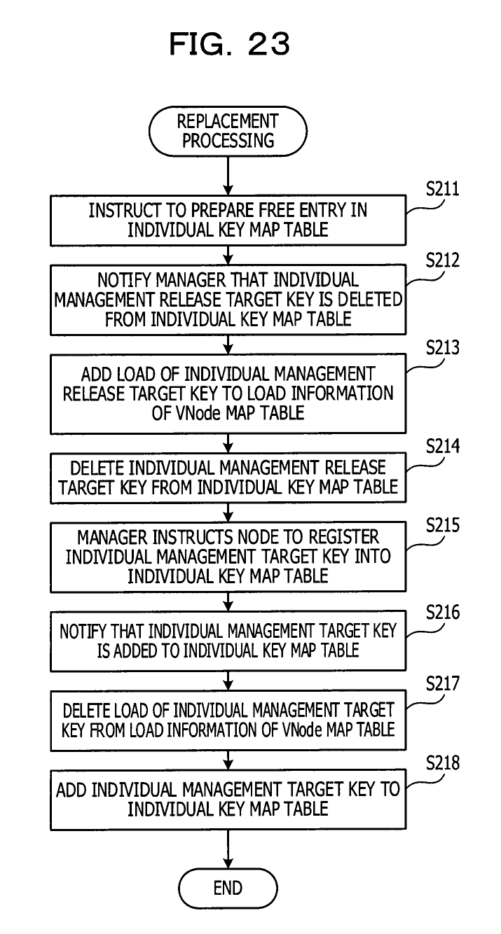

(Step S193) Each of nodes performs replacement (individual management or individual management release) of a determined replacement target key. Detail of the replacement processing is described later (see FIG. 23).

FIG. 22 is a flowchart illustrating an example of a procedure for the replacement target determination processing.

(Step S201) Each of the nodes 100, 100a, 100b, and 100c notifies, to the manager 210, load information (CPU use rate, memory usage, and so on) of the VNode to which a key of the event being processed by the own node is attached.

(Step S202) The manager 210 selects a predetermined number of VNodes in descending order of the load on VNode, as an extraction source of the individual management target key. Alternatively, the manager 210 may select a predetermined number of VNodes in descending order of the number of storable keys as an extraction source of the individual management target key. By using a VNode having a large number of storable keys as an extraction source of the individual management target key, equalization of the number of storable keys among VNodes may be facilitated. If the VNode is selected based on the number of storable keys, the load information in the step S201 does not have to be notified, and thereby processing efficiency may be enhanced.

The manager 210 instructs a node processing an event having a key included in the selected VNode to select an individual management target key from the VNode. Hereinafter, assume that the instruction has been given to the node 100.

(Step S203) The regular adjustment part 123d of the node 100 selects a key included in a VNode selected by the manager 210 as a candidate key for the individual management.

(Step S204) The regular adjustment part 123d notifies the candidate key and the load information thereof to the manager 210.

(Step S205) The manager 210 determines, out of candidate keys, a predetermined number of keys having a high load as individual management target keys.

(Step S206) The manager 210 determines, out of keys individually managed in the individual key map table 123b of the node 100, a predetermined number of keys having a low load as individual management release keys. The manager 210 determines whether there are free entries in the individual key map table 123b enough to store individual management target keys. If the number of free entries is not enough, the regular adjustment part 123d selects keys by the number of free entries in shortage out of the individual key map table 123b in the ascending order of the load, as individual management release target keys.

FIG. 23 is a flowchart illustrating an example of a procedure for the replacement processing.

(Step S211) The manager 210 instructs the node 100 to prepare free entries corresponding to the number of individual management target keys in the individual key map table 123b. When giving the instruction, the manager 210 notifies individual management release target keys to the node 100.

(Step S212) The regular adjustment part 123d of the node 100 notifies the manager 210 that the entry of the individual management release target keys is deleted from the individual key map table 123b. This notification may be given after the step S214.

(Step S213) The regular adjustment part 123d adds the load of the individual management release target key to the load information of an entry for a hash value of the key in the VNode map table 123a. For example, the regular adjustment part 123d adds the CPU load of the individual management release target key to the total CPU load, and adds the memory usage thereof to the total memory usage. Also, the regular adjustment part 123d additionally registers the key value and load information of the individual management release target key to the individual key load information. Further, the regular adjustment part 123d adds the number of individual management release target keys to the number of storable keys.

(Step S214) The regular adjustment part 123d deletes the entry of the individual management release target keys from the individual key map table 123b.

(Step S215) The manager 210 instructs the node 100 to register the individual management target key into the individual key map table 123b.

(Step S216) The regular adjustment part 123d of the node 100 registers the individual management target key into the individual key map table 123b, and notifies the manager that the individual management target key has been added.

(Step S217) The regular adjustment part 123d adds the load of the individual management release target key to the load information of an entry for a hash value of the key in the VNode map table 123a. For example, the regular adjustment part 123d subtracts the CPU load of the individual management target key from the total CPU load, and subtracts the memory usage thereof from the total memory usage. Also, the regular adjustment part 123d deletes the key value and load information of the individual management target key from the individual key load information. Further, the regular adjustment part 123d subtracts the number of individual management target keys from the number of storable keys.

(Step S218) The regular adjustment part 123d adds the entry of the individual management release target key to the individual key map table 123b.

Thus, management unit replacement of a key managed on the key basis and a key managed on a VNode basis with each other is performed. When the replacement is performed, a key having a high load out of keys included in a VNode having a high load undergoes the individual management, and a key having a low load out of keys managed on the key basis undergoes the individual management release. This reduces the difference between statistical values (total CPU load or total memory usage) of the load of each VNode and the load (CPU load or memory usage) of each key managed on the key basis.

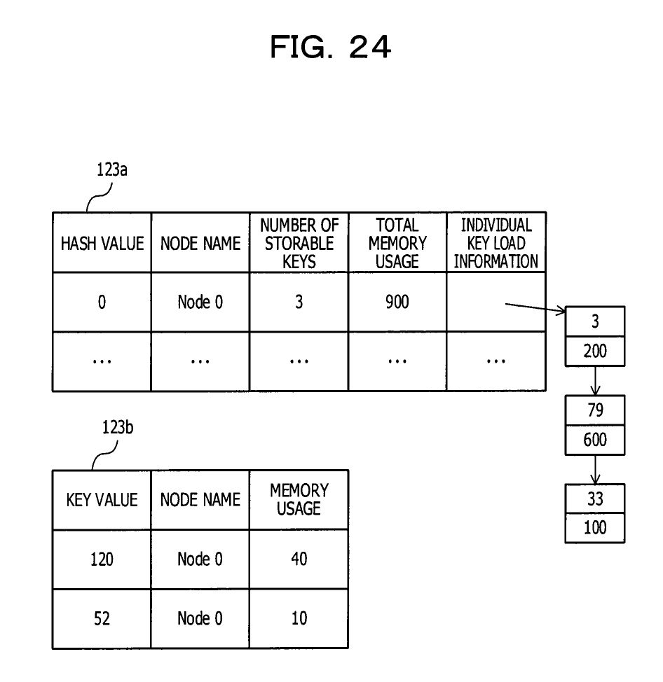

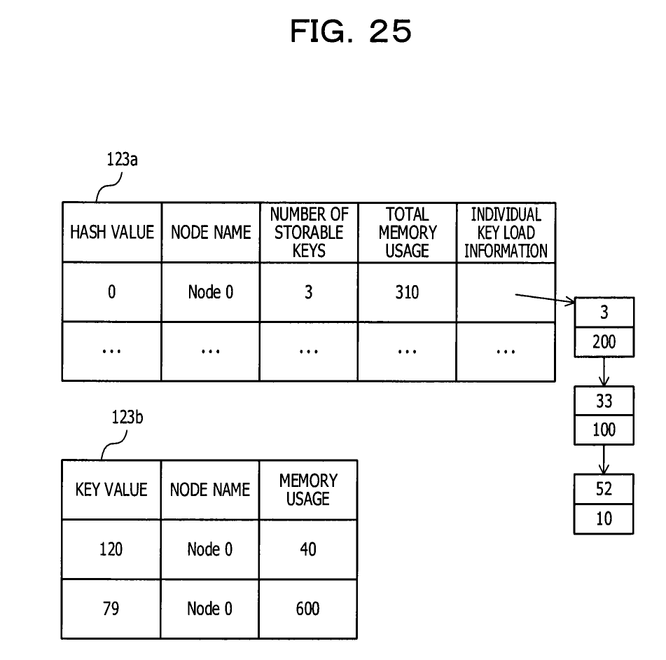

Next, an example of replacing individually managed keys is described with reference to FIG. 24 and FIG. 25.

FIG. 24 illustrates a state prior to the replacement. In the example of FIG. 24, the VNode having the hash value of “0” is selected as the extraction source of the individually managed key. Presently, there are three keys included in the VNode. The maximum number of entries in the individual key map table 123b is two. Presently, two entries are registered in the individual key map table 123b. Loaded information used for determining the necessity of replacement is the memory usage only. The number of keys selected at one time for replacement is one.

In the example of FIG. 24, since the VNode used as the extraction source of the individually managed key has been selected, a key having a highest load is selected as a key to be managed individually out of keys (with key values of “3”, “79”, and “33”) included in the selected VNode. In the example of FIG. 24, a key with the key value of “79” has a highest load with the memory usage of “600”. Therefore, the key with the key value of “79” is selected as a key to be managed individually.

From the individual key map table 123b, a key with a lowest load is selected as a key to be released from the individual management. In the example of FIG. 24, a key with the key value of “52” has a lowest load with the memory usage of “10”. Therefore, the key with the key value of “52” is selected as a key to be released from the individual management.

Then, a load of a key to be managed individually, and a load of a key to be released from the individual management are compared with each other. If the load of a key to be individually managed is higher, the replacement is authorized. In the example of FIG. 24, the load of a key (with the key value of “79”) to be managed individually is “600”, which is higher than the load of “10” of a key (with the key value of “52”) to be released from the individual management. Therefore, the replacement is authorized.

If the replacement is authorized, the regular adjustment part 123d notifies the manager 210 that a key with the key value of “52” is a key to be released from the individual management. Next, the number of storable keys in the entry of the hash value of “0” in the VNode map table 123a is incremented by 1 to “4”. The total memory usage is incremented by 10 to “910”. Also, load information of the key with the key value of “52” is added to the individual key load information in the VNode map table 123a. Then, the entry of the key with the key value of “52” is deleted from the individual key map table 123b. Thus, a free entry is reserved in the individual key map table 123b.

Once a free entry has been prepared, the regular adjustment part 123d notifies the manager 210 that the key with the key value of “79” is a key to be managed individually. Next, the number of storable keys in the entry of the hash value of “0” in the VNode map table 123a is subtracted by 1 to “3”. Further, the total memory usage is subtracted by “600” to “310”. Load information of the key with the key value of “79” is deleted from the individual key load information in the VNode map table 123a. Then, the entry of the key with the key value of “79” is added to the individual key map table 123b.

FIG. 25 illustrates a state after the replacement. As illustrated in FIG. 25, by replacing keys managed on the key basis, the load of the VNode with the hash value of “0” has decreased, and the load of a key with a smallest load among keys managed on the key basis has increased. As a result, the difference between the load of the VNode and the load of keys managed on the key basis becomes small. With reduction of the load difference therebetween, load equalization among nodes may be facilitated when changing a node processing an event having a key included in a VNode, or when changing a node processing an event having a key included in a key managed on the key basis. For example, if there is a VNode having a significantly high load, any node processing an event having a key included in the VNode undergoes an overload. By performing the replacement processing described above, occurrence of an excessive high load to the VNode may be reduced. Consequently, load equalization among nodes may be facilitated.

Although processings in the second embodiment illustrated in FIG. 12 to FIG. 23 are executed in coordination among the manager 210 of the management node 200 and elements of the nodes 100, 100a, 100b, and 100c, the processings may be entirely executed by any one (for example, the management node) of devices.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A system comprising:
circuitry configured to
receive a plurality of pieces of data;
store, for each of the plurality of pieces of data in a first memory area, a first identifier and associated node information identifying a node that processes associated piece of data;
delete a first identifier, among the first identifiers, from the first memory area in a case that a number of first identifiers stored in the first memory area reaches a threshold;
generate a second identifier based on the deleted first identifier by applying a predetermined calculation on the deleted first identifier, the second identifier being shorter than the first identifier;
store, in a second memory area, the second identifier and the associated node information identifying the node that processes the piece of data corresponding to the second identifier;
cause a node associated with one of the first identifiers stored in the first memory area to process one of the plurality of pieces of data in a case that the one of the first identifiers corresponding to the one of the plurality of pieces of data is stored in the first memory area; and
cause the node associated with the second identifier stored in the second memory area to process the piece of data corresponding to the second identifier in a case that the second identifier is stored in the second memory area.

2. The system of claim 1, wherein the circuitry is configured to:
store, in the first memory area, load information indicating a load corresponding to each of the plurality of pieces of data; and
delete the first identifier from the first memory area based on the load information in a case that the number of first identifiers stored in the first memory area reaches the threshold.

3. The system of claim 2, wherein
the circuitry is configured to delete a plurality of first identifiers in ascending order of load indicated by the load information out of the first identifiers stored in the first memory area.

4. The system of claim 2, wherein the circuitry is configured to:
store the second identifier and the load information corresponding to the deleted first identifier into the second memory area;
select, in a case that the number of first identifiers stored in the first memory area is less than the threshold, a second identifier of a plurality of second identifiers stored in the second memory area based on the load information;
generate a first identifier corresponding to the selected second identifier; and
store the generated first identifier, node information corresponding to the selected second identifier and the load information corresponding to the selected second identifier to the first memory area.

5. The system of claim 4, wherein
the circuitry is configured to select a plurality of second identifiers in descending order of load indicated in the load information in a case that the number of first identifiers stored in the first memory area is less than the threshold.

6. The system of claim 4, wherein the circuitry is configured to:
select a plurality of second identifiers from the second memory area in descending order of load indicated in the load information of the first identifier associated with the second identifier when the number of first identifiers stored in the first memory area is less than the threshold; and
select a first identifier based on the load information out of the first identifiers associated with the selected second identifiers.

7. The system of claim 2, wherein
the circuitry is configured to reduce a load difference among multiple nodes by changing the first node information associated with a first identifier in the first memory area and the second node information associated with a second identifier in the second memory area.

8. The system of claim 1, further comprising:
a plurality of nodes each configured to perform processing corresponding to the plurality of pieces of data received by the circuitry.

9. The system of claim 2, further comprising:
a plurality of nodes each including the circuitry according to claim 2, wherein
each of the circuitry is configured to modify a node identifier corresponding to at least one of the first identifiers based on the load corresponding to the at least one of the first identifiers.

10. The system of claim 9, further comprising:
a management node configured to
acquire, from each of the plurality of nodes, information of load to be executed in each of the plurality of nodes; and
reduce a load difference among the plurality of nodes by instructing each of the plurality of nodes to modify the node identifier based on the acquired information of load.

11. The system of claim 2, wherein
the system is a node that processes at least one of the plurality of pieces of the data.

12. A method comprising:
receiving a plurality of pieces of data;
storing, by circuitry, for each of the plurality of pieces of data in a first memory area, a first identifier and associated node information identifying a node that processes associated piece of data;
deleting, by the circuitry, a first identifier, among the first identifiers, from the first memory area in a case that a number of first identifiers stored in the first memory area reaches a threshold;
generating, by the circuitry, a second identifier based on the deleted first identifier by applying a predetermined calculation on the deleted first identifier, the second identifier being shorter than the first identifier;
storing, by the circuitry, in a second memory area, the second identifier and the associated node information identifying the node that processes the piece of data corresponding to the second identifier;
cause, by the circuitry, a node associated with one of the first identifiers stored in the first memory area to process one of the plurality of pieces of data in a case that the one of the first identifiers corresponding to the one of the plurality of pieces of data is stored in the first memory area; and
cause, by the circuitry, the node associated with the second identifier stored in the second memory area to process the piece of data corresponding to the second identifier in a case that the second identifier is stored in the second memory area.

13. The method of claim 12, further comprising:
storing, by the circuitry, in the first memory area, load information indicating a load corresponding to each of the plurality of pieces of data; and
deleting the first identifier from the first memory area based on the load information in a case that the number of first identifiers stored in the first memory area reaches the threshold.

14. The method of claim 13, wherein
the deleting the first identifier includes deleting, by the circuitry, a plurality of first identifiers in ascending order of load indicated by the load information out of the first identifiers stored in the first memory area.

15. The method of claim 13, further comprising:
storing, by the circuitry, the second identifier and the load information corresponding to the deleted first identifier into the second memory area;
selecting, by the circuitry, in a case that the number of first identifiers stored in the first memory area is less than the threshold, a second identifier of a plurality of second identifiers stored in the second memory area based on the load information;
generating, by the circuitry, a first identifier corresponding to the selected second identifier; and
storing, by the circuitry, the generated first identifier, node information corresponding to the selected second identifier and the load information corresponding to the selected second identifier to the first memory area.

16. The method of claim 15, wherein
the selecting the second identifier from the second memory area includes selecting a plurality of second identifiers in descending order of load indicated in the load information in a case that the number of first identifiers stored in the first memory area is less than the threshold.

17. The method of claim 15, wherein the selecting the second identifier from the second memory area includes:
selecting, by the circuitry, a plurality of second identifiers from the second memory area in descending order of load indicated in the load information of the first identifier associated with the second identifier, and
selecting, by the circuitry, a first identifier based on the load information out of the first identifiers associated with the selected second identifiers.

18. The method of claim 13, further comprising:
reducing, by the circuitry, a load difference among multiple nodes by changing the first node information associated with a first identifier in the first memory area and the second node information associated with a second identifier in the second memory area.

19. A non-transitory computer readable medium storing therein a program that causes a computer to execute a process, the process comprising:
receiving a plurality of pieces of data;
storing, for each of the plurality of pieces of data in a first memory area, a first identifier and associated node information identifying a node that processes associated piece of data;
deleting a first identifier, among the first identifiers, from the first memory area in a case that a number of first identifiers stored in the first memory area reaches a threshold;
generating a second identifier based on the deleted first identifier by applying a predetermined calculation on the deleted first identifier, the second identifier being shorter than the first identifier;
storing, in a second memory area, the second identifier and the associated node information identifying the node that processes the piece of data corresponding to the second identifier;
cause a node associated with one of the first identifiers stored in the first memory area to process one of the plurality of pieces of data in a case that the one of the first identifiers corresponding to the one of the plurality of pieces of data is stored in the first memory area; and
cause the node associated with the second identifier stored in the second memory area to process the piece of data corresponding to the second identifier in a case that the second identifier is stored in the second memory area.
